(19) United States
(12) Patent Application Publication
(10) Pub. No.: US 2014/0363991 A1
(43) Pub. Date: Dec. 11, 2014

(54) ULTRA LOW-PROFILE CONNECTORS

(71) Applicant: Samtec, Inc., New Albany, IN (US)

(72) Inventors: Craig Francis RYAN, Floyds Knobs, IN (US); Tobias Scott SWITZER, Borden, IN (US); Gregory Leo REIDINGER, New Albany, IN (US); Dale Francis SCHMELZ, Depauw, IN (US); William Chieng OUYANG, New Albany, IN (US)

(21) Appl. No.: 14/468,659

(22) Filed: Aug. 26, 2014

Related U.S. Application Data
(63) Continuation-in-part of application No. 13/688,392, filed on Nov. 29, 2012.

(51) Int. Cl. H01R 12/71

(52) U.S. Cl. CPC H01R 12/718
USPC 439/74

(57) ABSTRACT

A connector system includes a first connector including first contacts arranged around a pass-through hole or a recess, the first connector being configured to be located in a cut-out of a first substrate such that the first contacts are connected to the first substrate, and a second connector including second contacts arranged around a beam, the second connector configured to be connected to a second substrate such that the second contacts are connected to the second substrate. The pass-through hole or the recess extends in a mating direction of the first connector and the second connector, and the beam of the second connector is configured to extend into the pass-through hole or the recess of the first connector when the first connector and the second connector are mated such that the first contacts engage with respective ones of the second contacts.

### CROSS-REFERENCE TO RELATED APPLICATIONS

This application is a Continuation-In-Part of U.S. patent application Ser. No. 13/688,392 filed on Nov. 29, 2012, currently pending, the entire contents of which are hereby incorporated by reference.

### BACKGROUND OF THE INVENTION

1. Field of the Invention

The present invention relates to electrical connectors. More specifically, the present invention relates to mezzanine and edge connectors having low profiles.

2. Description of the Related Art

Electrical connectors are used to allow electrical devices, such as substrates or printed circuit boards, to communicate with one another. A connector may be thought of as having two portions, a first portion which connects to a first electrical device and a second portion which connects to a second electrical device to be put into communication with the first device. To connect the two electrical devices, the two portions of the connector are mated together.

Each connector includes one set of contacts in a first portion and a second set of contacts in a second portion to be connected with the contacts of the first portion. This can be readily accomplished by providing a male connector and a female connector, or a socket connector and a receptacle connector, with corresponding sets of contacts that engage when the male and female connectors or the socket and receptacle connectors are mated. Further, the male and female connectors or the socket and receptacle connectors are easily connected and disconnected from each other to respectively electrically connect and disconnect the electrical devices to which they are connected.

Accordingly, each connector portion is connected to an electrical device through its contacts. The contacts are typically permanently connected to the electrical device. Further, the connector portions are typically secured to electrical devices by fusing the contacts to connection pads or other suitable structure provided on the electrical device.

Recently, there has been a trend toward miniaturization of most electrical devices. As electrical devices become smaller and more complex, the connectors used with these electrical devices must also become smaller and must be able to accommodate the more complex electrical devices. One problem with miniaturized connectors arises from the increased precision (i.e., tighter tolerances) of placement necessary to produce the proper positioning and connection of the connector contacts onto the electrical device. This problem is exacerbated by the ever-increasing input/output (I/O) density requirements demanded of the progressively smaller connectors by increasingly miniaturized electrical devices. As the number of contacts increases in each connector, it becomes more and more difficult to maintain desired levels of co-planarity, while maintaining connection of all of the contacts to a substrate.

In order to provide for a higher density of substrates, mezzanine connectors have been used. Mezzanine connectors are typically used to connect a first substrate to a second substrate in a parallel manner. A conventional mezzanine connector assembly includes a male connector to be mounted on one substrate, and a female connector to be mounted on another substrate. The male connector includes a plurality of contacts that each engages a corresponding contact on the female connector when the male connector and the female connector are mated, thereby establishing electrical contact between the two substrates. The individual electrical contacts in the male and female connectors are used to conduct electrical signals or electrical power. Examples of mezzanine connectors can be found in U.S. Pat. No. 6,702,590 and U.S. Pat. No. 6,918,776.

As the progression toward higher density continues, it has become useful to reduce the distance between substrates that are connected by mezzanine connectors by modifying the structure of the mezzanine connectors. However, conventional mezzanine connectors have a number of problems, as described below.

As shown in FIGS. 6 and 7 of U.S. Pat. No. 6,702,590, one problem with conventional mezzanine connectors is that the distance between the substrates is limited by the heights of the terminal and the socket. That is, the terminal is only partially inserted into the socket, such that the heights of both the terminal and the socket significantly contribute to the overall height of the mated terminal and socket and thus the distance between the substrates.

As shown in FIGS. 48 and 49 of U.S. Pat. No. 6,702,590, another problem with conventional mezzanine connectors is that reducing the heights of the terminal and/or socket also reduces wipe distances of the contacts when the terminal and socket are connected, which may negatively affect the performance and longevity of the electrical connection. A wipe distance between corresponding contacts refers to the distance between a first point where the corresponding contacts initially touch during mating of the terminal and socket, and a second point where the contacts are positioned when the terminal and the socket are fully mated. Along the wipe distance, oxides and other substances are wiped off of the corresponding contacts due to their physical engagement, thereby improving a mechanical connection between the contacts. A short wipe distance may cause poor electrical performance due to a weak mechanical connection between the corresponding contacts.

Furthermore, poor electrical performance in mezzanine connectors may result from a force normal to the mating direction of the terminal and socket being insufficient to wipe off the oxides and other substances from the corresponding contacts. However, if the force normal to the mating direction of the terminal and the socket is too great, one or more of the contacts may bend or buckle when the terminal and socket are mated. Accordingly, proper alignment between the terminal and the socket during mating is important to help ensure that the force normal to the mating direction of the terminal and the socket is sufficient to wipe off the oxides and other substances from the corresponding contacts, yet insufficient to cause any of the contacts to bend or buckle. As an example, cantilevered contacts are particularly susceptible to variations in the force normal to the mating direction of the terminal and the socket.

As shown in FIG. 1 of U.S. Pat. No. 6,918,776, an additional problem with conventional mezzanine connectors is that the distance between the substrates is also limited due to both the terminal and the socket being mounted on the surface of substrate. That is, the distance between each of the terminal and the socket and a surface of each of the substrates contributes to the distance between the substrates.

A further problem with conventional connectors is the use of multiple folded contacts in the terminal and socket that require the width of the connector to be much wider. For example, the Panasonic P5KF series of mezzanine connectors have contacts that are folded over multiple times, which causes these connectors to have a substantial width.

### SUMMARY OF THE INVENTION

To overcome the problems described above, preferred embodiments of the present invention provide a mezzanine connector and an edge connector each with low profiles and long contact wipe distances.

A connector system according to a preferred embodiment of the present invention includes a first connector including a pass-through hole or a recess and a first plurality of contacts arranged in at least one row around the pass-through hole or the recess, the first connector being configured to be located in a cut-out of a first substrate such that the first plurality of contacts are connected to the first substrate, and a second connector including a beam and a second plurality of contacts arranged in at least one row around the beam, the second connector configured to be located in a cut-out of the second substrate such that the second plurality of contacts are connected to the second substrate. The pass-through hole or the recess extends in a mating direction of the first connector and the second connector. The beam of the second connector is configured to extend into the pass-through hole or the recess of the first connector when the first connector and the second connector are mated such that each of the first plurality of contacts engages with a respective one of the second plurality of contacts. A contact point between the first plurality of contacts and the second plurality of contacts when the first connector is mated with the second connector is located between facing major planar surfaces of the first substrate and the second substrate or between a first major planar surface and a second major planar surface of the first substrate. A bottom surface of the beam of the second connector is arranged between the first and second major planar surfaces of the first substrate when the first connector is mated with the second connector, or the bottom surface of the beam of the second connector is co-planar or substantially co-planar to a first major planar surface and a second major planar surface of the first connector when the first connector is mated with the second connector.

Preferably, a wipe distance of the first plurality of contacts and the second plurality of contacts is greater than a distance between the first substrate and the second substrate when the first connector is mated with the second connector. Preferably, the wipe distance of the first plurality of contacts and the second plurality of contacts is greater than a thickness of the first substrate when the first connector is mated with the second connector.

Preferably, the first connector is soldered to the first substrate and the second connector is soldered to the second substrate. The first plurality of contacts is preferably arranged in at least two rows, and the second plurality of contacts is preferably arranged in at least two rows. The rows of the first plurality of contacts are preferably offset with respect to each other, and the rows of the second plurality of contacts are preferably offset with respect to each other.

A socket connector system according to a preferred embodiment of the present invention includes a plurality of contacts and a pass-through hole or a recess. The socket connector is configured to be located in a cut-out of a substrate, the plurality of contacts is arranged in at least one row along the pass-through hole or the recess, and the pass-through hole or the recess extends such that when the socket connector mates with another connector, a bottom surface of the another connector is co-planar or substantially co-planar to a bottom surface of the socket connector.

Preferably, each of the plurality of contacts is arranged to engage with a corresponding one of a plurality of connection pads arranged proximate to an edge of an edge card, when the edge card is mated with the socket connector. A major planar surface of the edge card is preferably perpendicular or substantially perpendicular to a major planar surface of the substrate.

A connector assembly according to a preferred embodiment of the present invention includes a first connector including a pass-through hole and a first plurality of contacts arranged along the pass-through hole, a second connector including a beam and a second plurality of contacts arranged along the beam, a first substrate, and a second substrate. The first connector is configured to be located in a cut-out of the first substrate or configured to be located at an edge of the first substrate. The second connector is configured to be located in a cut-out of the second substrate or configured to be located at an edge of the second substrate. The first connector is configured to be connected to the first substrate such that the first plurality of contacts is connected to the first substrate. The first connector includes a pass-through hole extending fully through the first connector in a mating direction of the first connector and the second connector. The second connector is configured to be connected to the second substrate such that the second plurality of contacts is connected to the second substrate. The beam of the second connector is configured to engage the pass-through hole of the first connector when the first connector and the second connector are connected such that each of the first plurality of contacts engages with a respective one of the second plurality of contacts.

Preferably, at least one of the first connector and the second connector includes at least one post to engage with at least one corresponding post hole in the first or second substrate.

The above and other features, elements, steps, configurations, characteristics and advantages of the present invention will become more apparent from the following detailed description of preferred embodiments of the present invention with reference to the attached drawings.

### BRIEF DESCRIPTION OF THE DRAWINGS

FIGS. 1 and 2 are a perspective view and a cross-sectional perspective view of a connector according to a first preferred embodiment of the present invention, including a socket and a terminal connected to respective first and second substrates.

FIGS. 3 and 4 are a perspective view and a cross-sectional perspective view of the socket shown in FIGS. 1 and 2 being inserted into the first substrate shown in FIGS. 1 and 2.

FIG. 5 is a cross-sectional end view of the socket, the terminal, and the first and second substrates shown in FIGS. 1 and 2.

FIGS. 6-9 are perspective views and cross-sectional views of the socket, the terminal, and the first and second substrates shown in FIGS. 1 and 2, when the terminal is mated with the socket at a first surface of the first substrate.

FIGS. 10 and 11 are cross-sectional end views of the socket, a modified terminal, and the first and second substrates shown in FIGS. 1 and 2, when the terminal is mated with the socket at a second surface of the first substrate.

FIGS. 12-14 are perspective views and a cross-sectional perspective view of a connector according to a second preferred embodiment of the present invention, including a socket and a terminal connected to respective first and second substrates.

FIG. 15 is a cross-sectional perspective view of the socket and the terminal shown in FIGS. 12-14 being respectively inserted into the first and second substrates shown in FIGS. 12-14.

FIG. 16 is a cross-sectional end view of the socket, the terminal, and the first and second substrates shown in FIGS. 12-14.

FIGS. 17-20 are perspective views and cross-sectional views of the socket, the terminal, and the first and second substrates shown in FIGS. 12-14, when the terminal is mated with the socket at a first surface of the first substrate.

FIGS. 21 and 22 are a perspective view and a cross-sectional perspective view of a connector according to a third preferred embodiment of the present invention, including a socket and a terminal connected to respective first and second substrates.

FIG. 23 is a cross-sectional perspective view of the socket and the terminal shown in FIGS. 21 and 22 being respectively inserted into the first and second substrates shown in FIGS. 21 and 22.

FIG. 24 is a cross-sectional end view of the socket, the terminal, and the first and second substrates shown in FIGS. 21 and 22.

FIGS. 25-27 are a perspective view and cross-sectional views of the socket, the terminal, and the first and second substrates shown in FIGS. 21 and 22, when the terminal is mated with the socket.

FIGS. 28 and 29 are a perspective view and a cross-sectional perspective view of an edge card arranged to mate with the socket and the first substrate shown in FIGS. 21 and 22, according to a fourth preferred embodiment of the present invention.

FIG. 30 is a cross-sectional end view of the edge card, the socket, and the first substrate shown in FIGS. 28 and 29.

FIGS. 31-33 are perspective views and a cross-sectional perspective view of the edge card, the socket, and the first substrate shown in FIGS. 28 and 29, when the edge card is mated with the socket.

FIGS. 34-36 are perspective views and a cross-sectional perspective view of a connector according to a fifth preferred embodiment of the present invention, including a socket and a terminal connected to respective first and second substrates.

FIG. 37 is a cross-sectional end view of the socket, the terminal, and the first and second substrates shown in FIGS. 34-36.

FIGS. 38-41 are perspective views and cross-sectional views of the socket, the terminal, and the first and second substrates shown in FIGS. 34-36, when the terminal is mated with the socket.

FIGS. 42-44 are perspective views and a cross-sectional perspective view of a connector according to a sixth preferred embodiment of the present invention, including a socket and a terminal connected to respective first and second substrates.

FIG. 45 is a cross-sectional end view of the socket, the terminal, and the first and second substrates shown in FIGS. 42-44.

FIGS. 46-48 are perspective views and a cross-sectional perspective view of the socket, the terminal, and the first and second substrates shown in FIGS. 42-44, when the terminal is mated with the socket.

FIGS. 49 and 50 are planar views of the socket, the terminal, and the first and second substrates shown in FIGS. 42-44.

FIG. 51 is a cross-sectional end view of the socket, the terminal, and the first and second substrates shown in FIGS. 42-44, when the terminal is mated with the socket.

FIGS. 52-55 are perspective views and a cross-sectional perspective view of a connector according to a seventh preferred embodiment of the present invention, including a socket and a terminal connected to respective first and second substrates.

FIG. 56 is a cross-sectional end view of the socket, the terminal, and the first and second substrates shown in FIGS. 52-55.

FIGS. 57-60 are perspective views and cross-sectional views of the socket, the terminal, and the first and second substrates shown in FIGS. 52-55, when the terminal is mated with the socket.

FIGS. 61-64 are perspective views and a cross-sectional perspective view of a connector according to an eighth preferred embodiment of the present invention, including a socket and a terminal connected to respective first and second substrates.

FIGS. 65-68 are perspective views and a cross-sectional perspective view of a connector according to a ninth preferred embodiment of the present invention, including a socket and a terminal connected to respective first and second substrates.

### DETAILED DESCRIPTION OF PREFERRED EMBODIMENTS

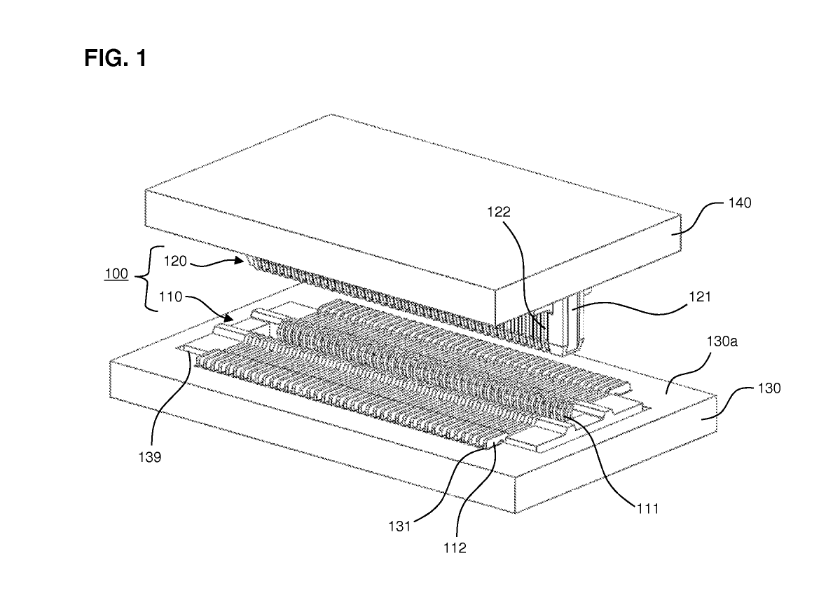

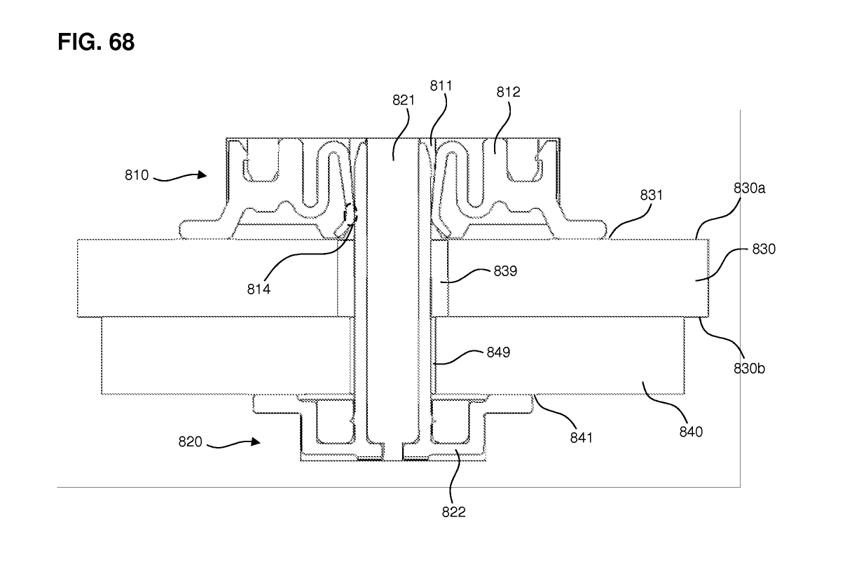

Preferred embodiments of the present invention will now be described in detail with reference to FIGS. 1 to 68. Note that the following description is in all aspects illustrative and not restrictive and should not be construed to restrict the applications or uses of the present invention in any manner.

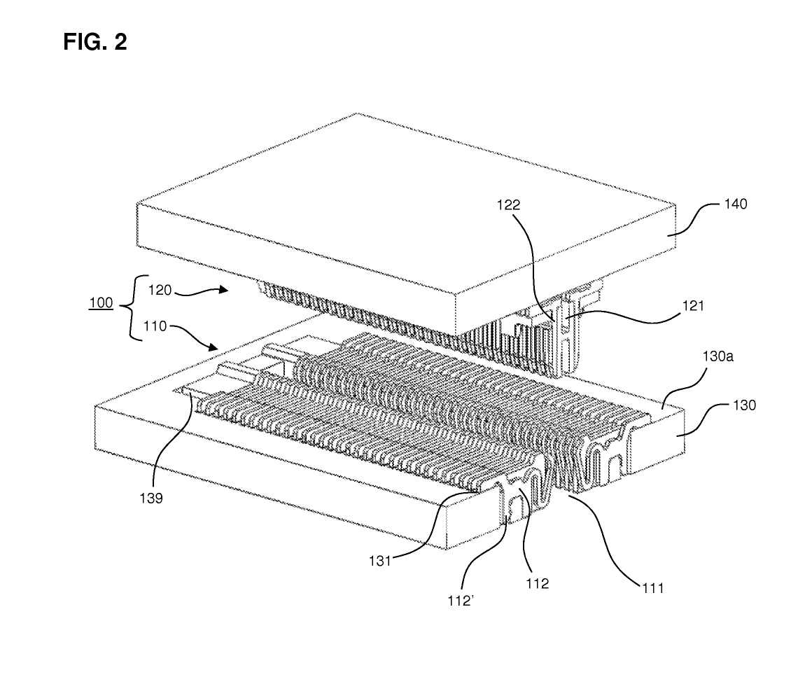

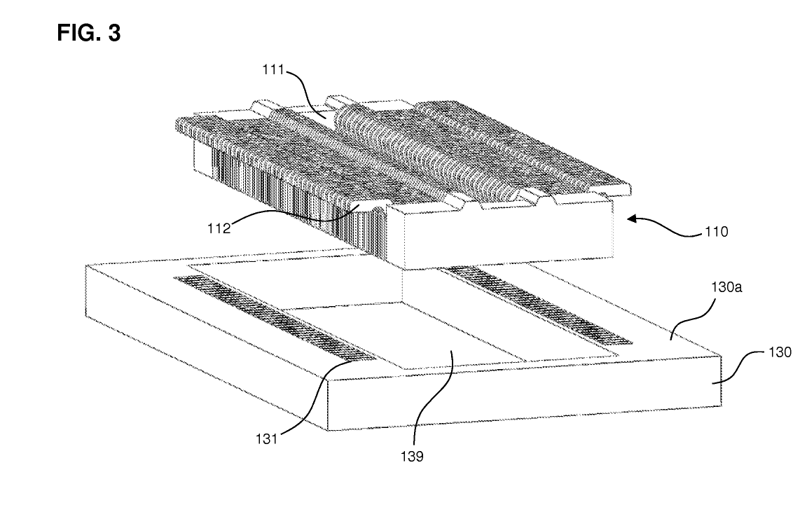

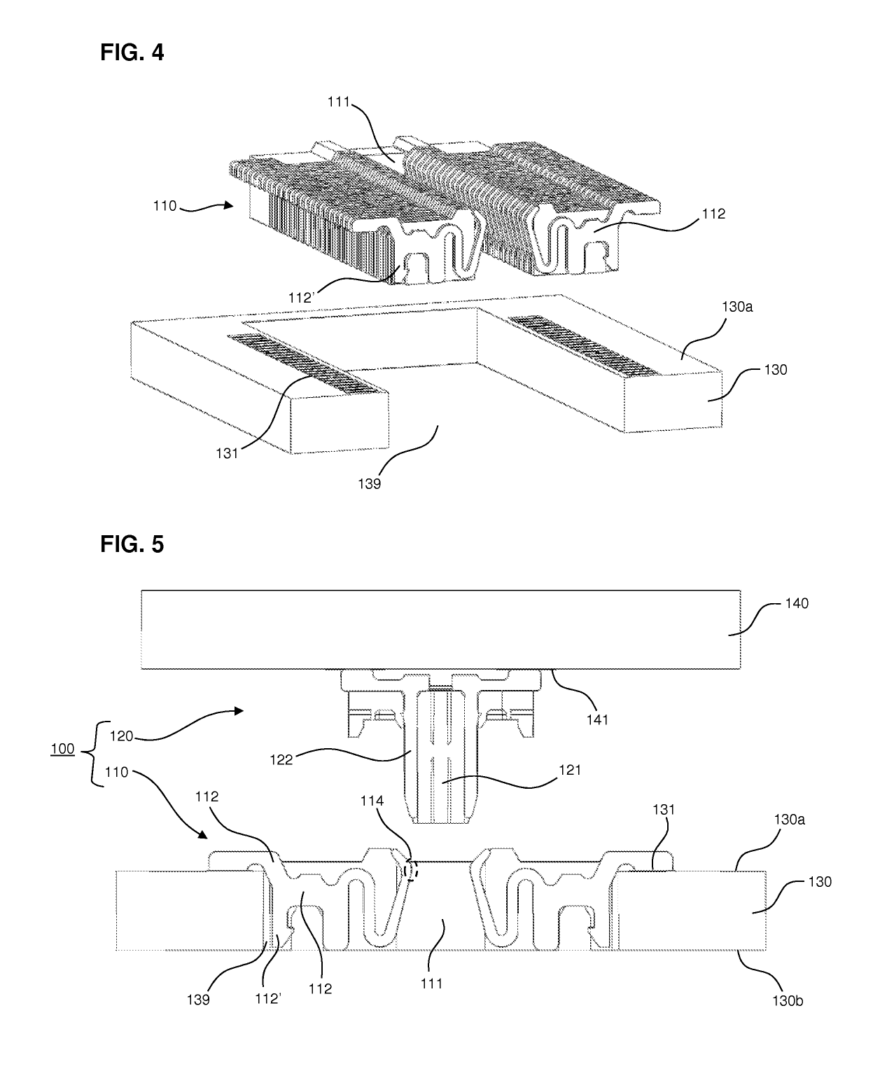

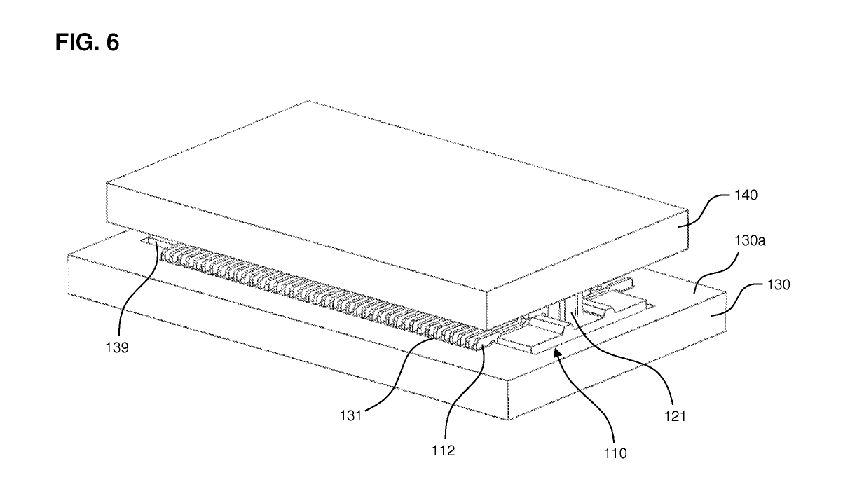

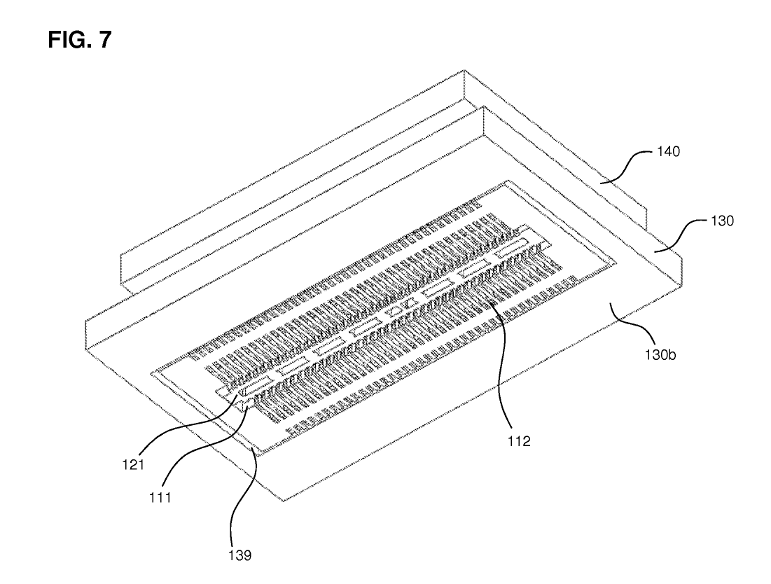

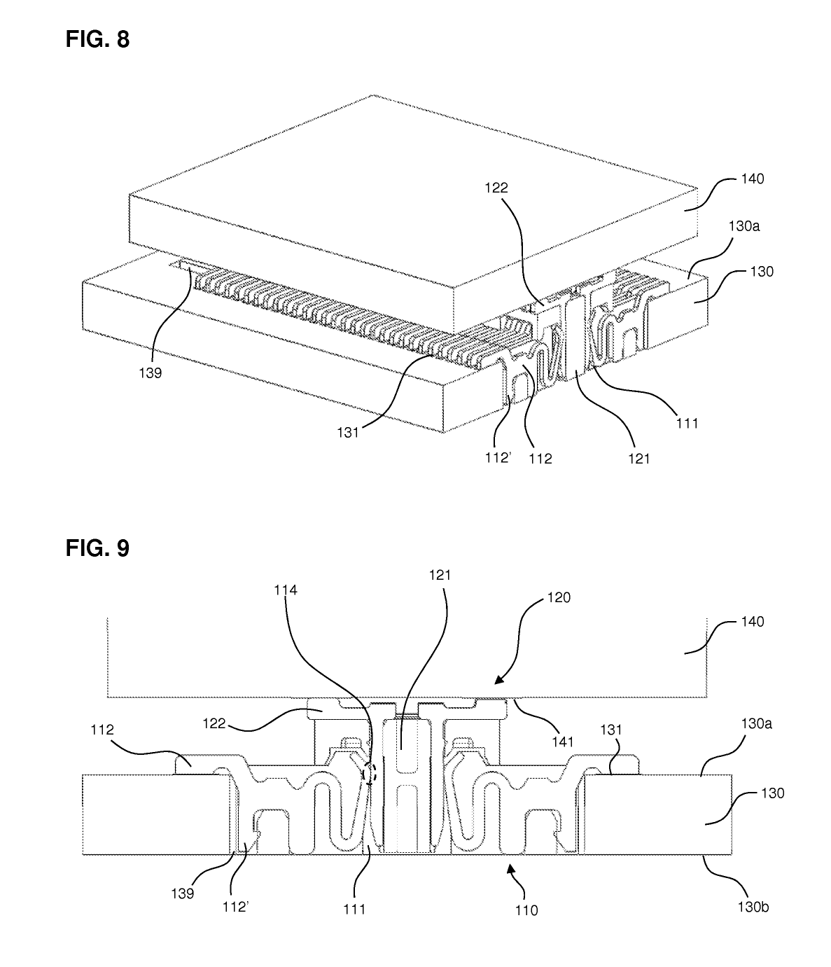

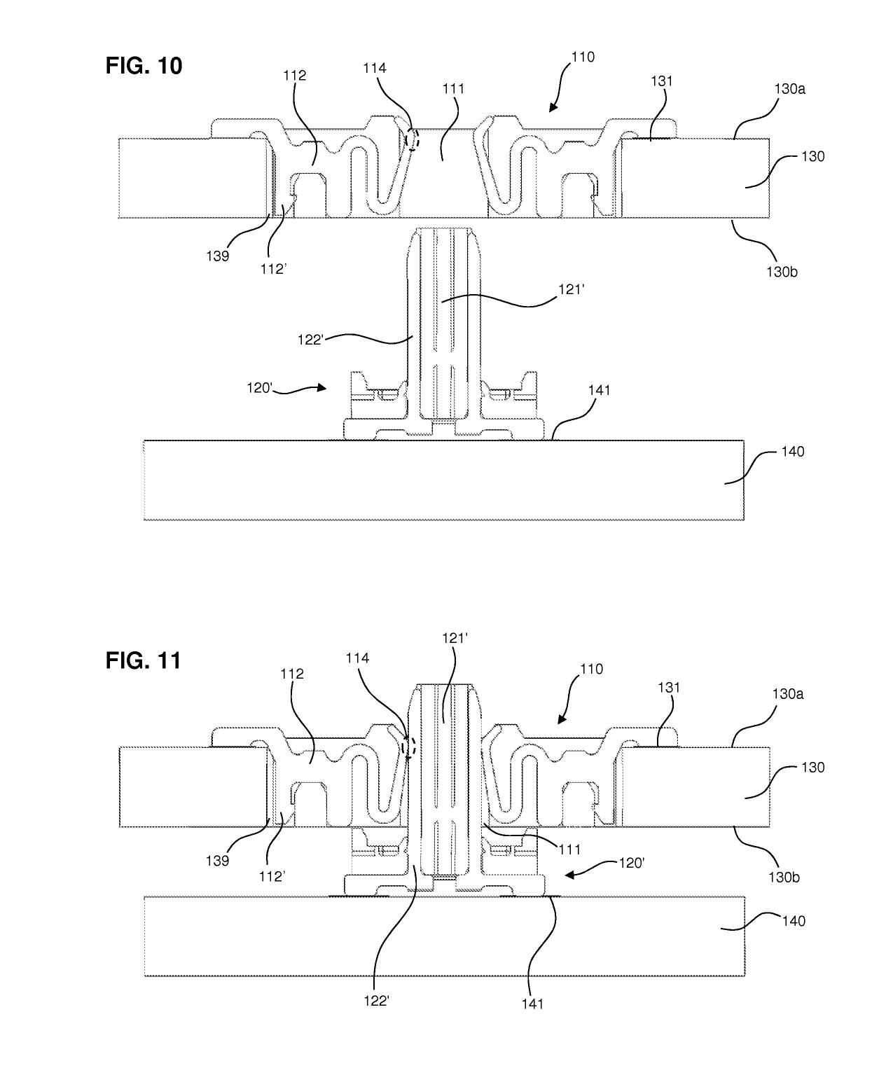

FIGS. 1-9 show a connector 100 in accordance with a first preferred embodiment of the present invention. FIGS. 1 and 2 are a perspective view and a cross-sectional perspective view of the connector 100, which includes a socket 110 and a terminal 120 that are respectively connected to a first substrate 130 and a second substrate 140. FIGS. 3 and 4 are a perspective view and a cross-sectional perspective view of the socket 110 being inserted into the first substrate 130. FIG. 5 is a cross-sectional end view of the socket 110, the terminal 120, the first substrate 130, and the second substrate 140. FIGS. 6-9 are perspective views and cross-sectional views of the socket 110, the terminal 120, the first substrate 130, and the second substrate 140, when the terminal 120 is mated with the socket 110 at a first surface 130a of the first substrate 130. FIGS. 10 and 11 are cross-sectional end views of the socket 110, a modified terminal 120′, the first substrate 130, and the second substrate 140, when the modified terminal 120′ is mated with the socket 110 at a second surface 130b of the first substrate 130.

As shown in FIGS. 1-9, the socket 110 includes socket contacts 112 that are respectively connected to connection pads 131 of the first substrate 130, and the terminal 120 includes terminal contacts 122 that are respectively attached to connection pads of 141 of the second substrate 140. Preferably, the socket contacts 112 and the terminal contacts 122 are each respectively arranged in two corresponding rows that are parallel or substantially parallel, within manufacturing tolerances, with respect to each other. The socket contacts 112 and the terminal contacts 122 are preferably connected to their respective connection pads 131 and 141 by a fusible material, such as solder. As an example, a reflow solder operation may be used to connect the socket contacts 112 and the terminal contacts 122 to their respective connection pads 131 and 141. Preferably, the socket contacts 112 and the terminal contacts 122 are fused to their respective connection pads 131 and 141 in separate operations, prior to the terminal 120 being mated with the socket 110. However, the socket contacts 112 and the terminal contacts 122 may instead be fused to their respective connection pads 131 and 141 at the same time or in sequential operations while the terminal 120 is mated with the socket 110.

Portions of the socket contacts 112 and the terminal contacts 122 that are arranged to connect to the connection pads 131 and 141 may include ribbed or multi-planar shapes (not shown) to help prevent the flow of the fusible material into a wipe area of the receptacle contacts 112 where contact points 114 of the socket contacts 112 touch the corresponding ones of the terminal contacts 122 when the terminal 120 is mated with the socket 110. Further, the fusible material may flow to the retaining arms 112′ of the socket contacts 112 that are press-fit into corresponding holes in the socket 110, thereby helping secure the socket contacts 112 to the socket 110 and preventing the fusible material from flowing to the wipe area and contact points 114 of the socket contacts 112.

The socket 110 includes a pass-through hole 111 arranged to receive a beam 121 of the terminal 120 when the terminal 120 is inserted into the socket 110. Preferably, the beam 121 does not protrude past a plane defined by a second surface 130b of the first substrate 130 when the terminal 120 is mated with the socket 110, as shown in FIG. 9. However, the beam 121 may alternatively be arranged to pass fully through the first substrate, for example, to additionally connect to another socket connector (not shown). Preferably, a distal surface of the beam 121 that is farthest away from the second substrate 140 is co-planar or substantially co-planar, within manufacturing tolerances, to the second surface 130b of the first substrate 130. The socket contacts 112 are exposed at the pass-through hole 111, and the terminal contacts 122 are exposed at the beam 121. Thus, the socket contacts 112 and the terminal contacts 122 are connected when the beam 121 is inserted into the pass-through hole 111.

As shown in FIGS. 1-9, the above-described arrangement of the socket 110 and the terminal 120 provides a stable physical and electrical connection between the socket 110 and the terminal 120.

Furthermore, the above-described arrangement of the socket 110 and the terminal 120 provides a long wipe distance between the socket contacts 112 and the terminal contacts 122, thereby cleaning oxides and other substances from the socket contacts 112 and the terminal contacts 122 when the terminal 120 is inserted into the socket 110. More specifically, the wipe distance indicates the distance along which the contact points 114 of the socket contacts 112 slide along the terminal contacts 122 when the terminal 120 is mated with the socket 110. Accordingly, an improved mechanical and electrical connection between the socket contacts 112 and the terminal contacts 122 is achieved.

As shown in FIGS. 2-5 and 7-11, the socket 110 is configured to fit into a cut-out 139 of the first substrate 130. Accordingly, since the socket 110 is recessed within the cut-out 139 of the first substrate 130, the beam 121 of the terminal 120 passes through a plane defined by the first surface 130a of the first substrate 130 when the terminal 120 is mated with the socket 110. Thus, when the terminal 120 is fully mated with the socket 110, as shown in FIGS. 6-9, only a small spacing exists between the first substrate 130 and the second substrate 140.

The above-described arrangement of the socket 110 and the terminal 120 provides a small spacing between the first substrate 130 and the second substrate 140, thus allowing a denser arrangement of substrates when the terminal 120 is fully mated with the socket 110 as shown in FIGS. 6-9.

As shown in FIGS. 5 and 9, the positions of the contact points 114 of the socket contacts 112 move due to a deflection in the socket contacts 112 that occurs as a result of the contact points 114 pressing against the terminal contacts 122 when the terminal 120 is inserted into the socket 110.

According to a preferred embodiment of the present invention, the contact point 114 of each of the socket contacts 112 when the terminal 120 is fully inserted into socket 110 may be at or above a plane defined by the first surface 130a of the first substrate 130 to provide a long wipe distance. Accordingly, the wipe distance may be greater than the thickness of the first substrate 130 or may be greater than the distance between the first substrate 130 and the second substrate 140 when the terminal 120 is inserted into the socket 110.

As shown in FIGS. 1, 2, and 5-9, the terminal 120 is preferably inserted into the socket 110 in a direction from the first surface 130a of the first substrate 130 to the second surface 130b of the first substrate 130, such that the second substrate 140 is closer to the first surface 130a of the first substrate 130 than to the second surface 130b of the first substrate 130. However, the terminal 120 may also be inserted in a direction opposite to that described above, that is, a direction from the second surface 130b of the first substrate 130 to the first surface 130a of the first substrate 130, such that the second substrate 140 is closer to the second surface 130b of the first substrate 130 than the first surface 130a of the first substrate 130. However, if the terminal 120 is mated with the socket 110 in this opposite direction, the wipe distance between the socket contacts 112 and the terminal contacts 122 can be reduced, and the amount of deflection in the socket contacts 112 can be reduced as compared with the arrangement shown in FIGS. 1, 2, and 5-9.

Accordingly, as shown in FIGS. 10 and 11, the modified terminal 120′ can be used for mating with the socket 110 in both directions described above because the modified terminal 120′ includes an extended beam 121′ and extended terminal contacts 122′ that provide a longer wipe distance along the socket contacts 112 in both directions.

Further, according to a preferred embodiment of the present invention, the contact point 114 when the terminal 120 is fully inserted into socket 110 may be located near the midpoint between the first and second surfaces 130a and 130b of the first substrate 130 in order to provide a moderate force for retaining the terminal 120 in the socket 110 regardless of the direction that the terminal 120 is inserted into the socket 110. Additionally, if the contact point 114 is located near the midpoint between the first and second surfaces 130a and 130b of the first substrate 130, the wipe distance between the socket contacts 112 and the terminal contacts 122 may be about the same regardless of the direction that the terminal 120 is inserted into the socket 110.

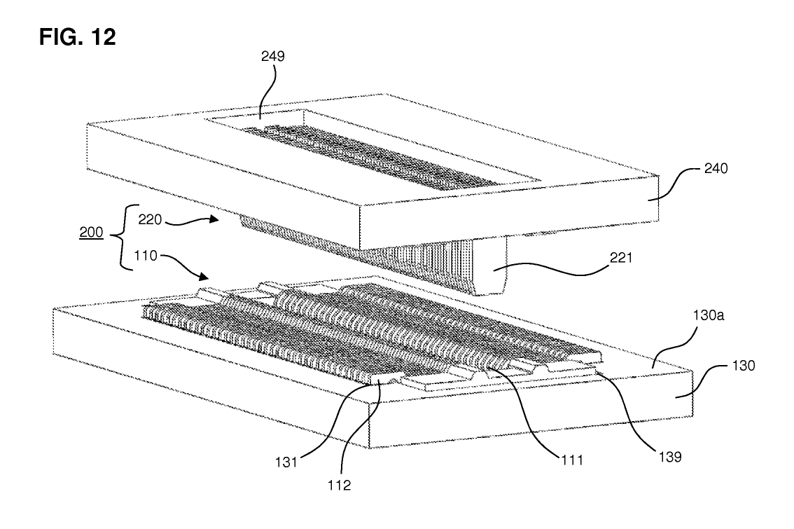

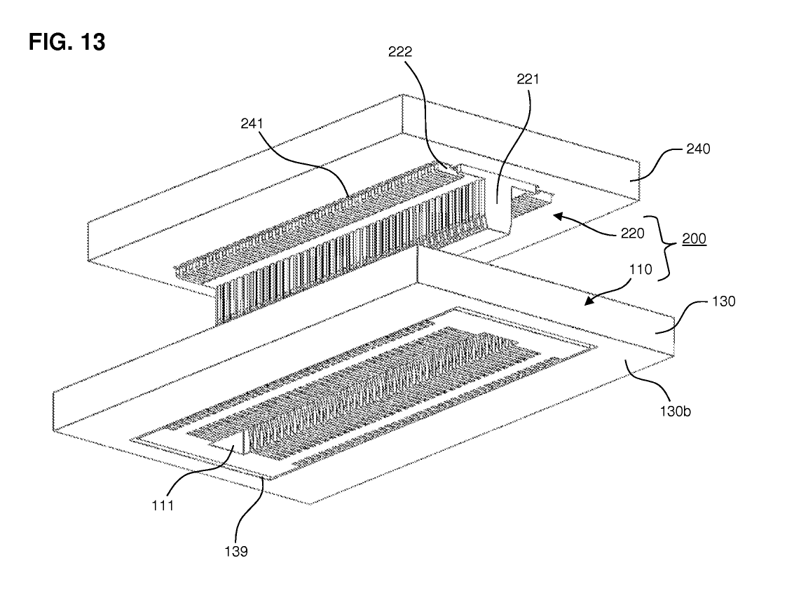

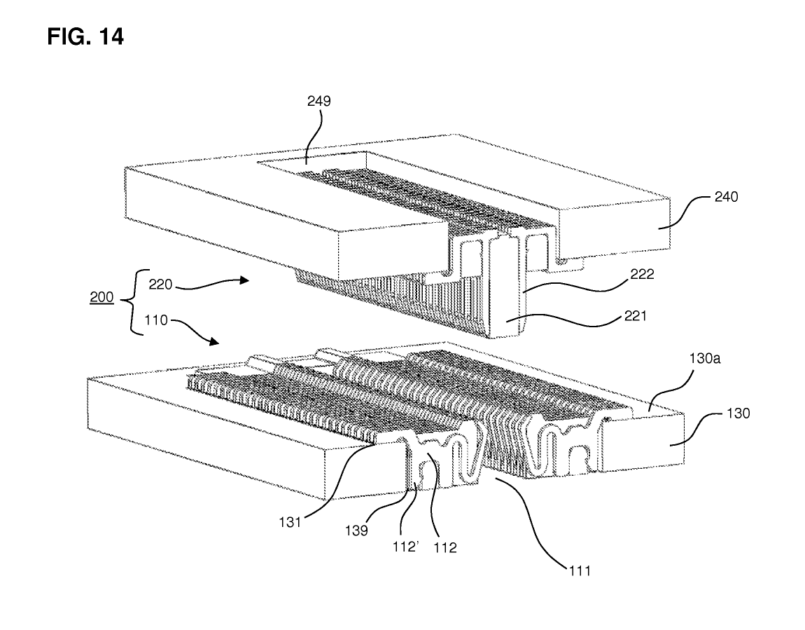

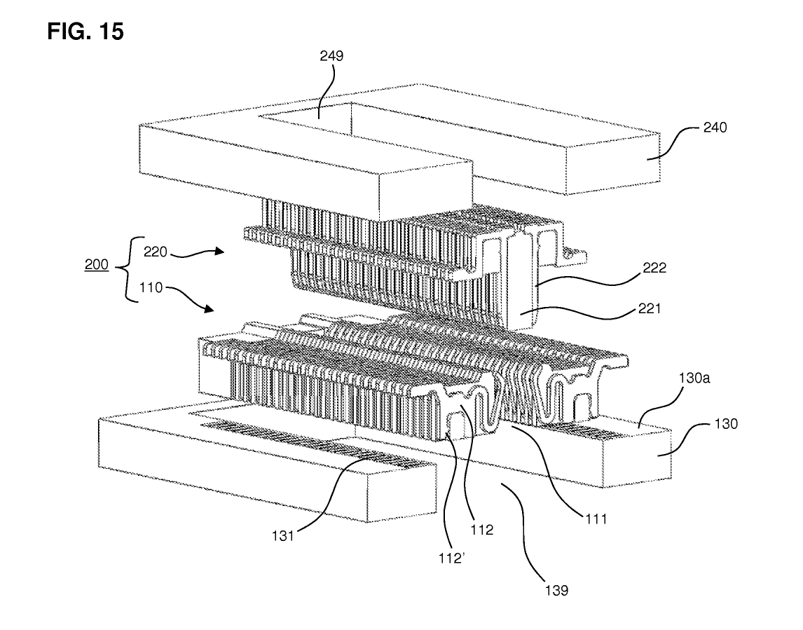

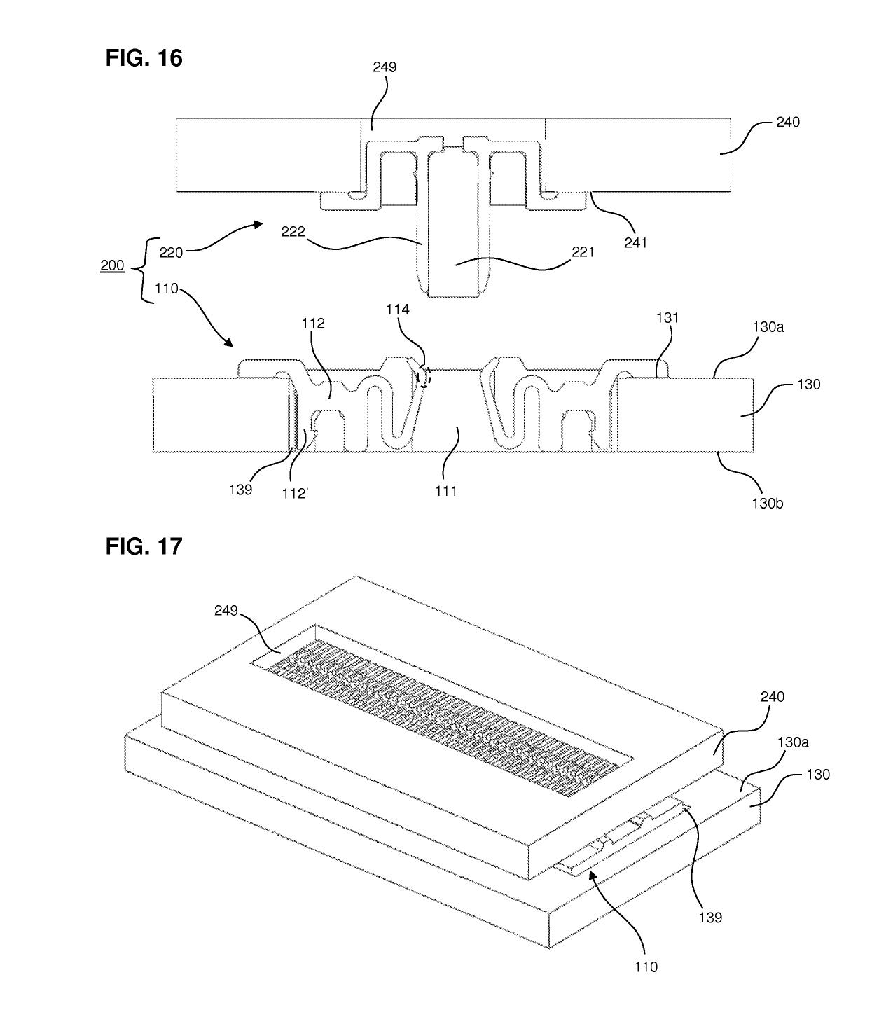

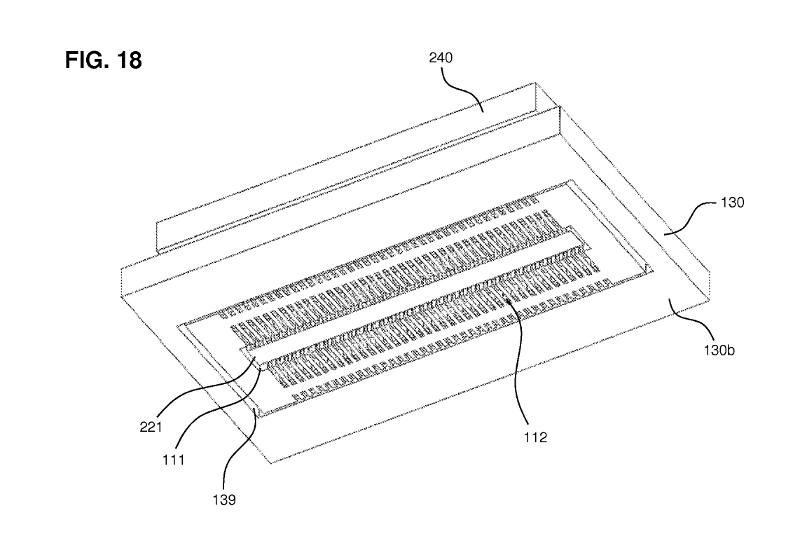

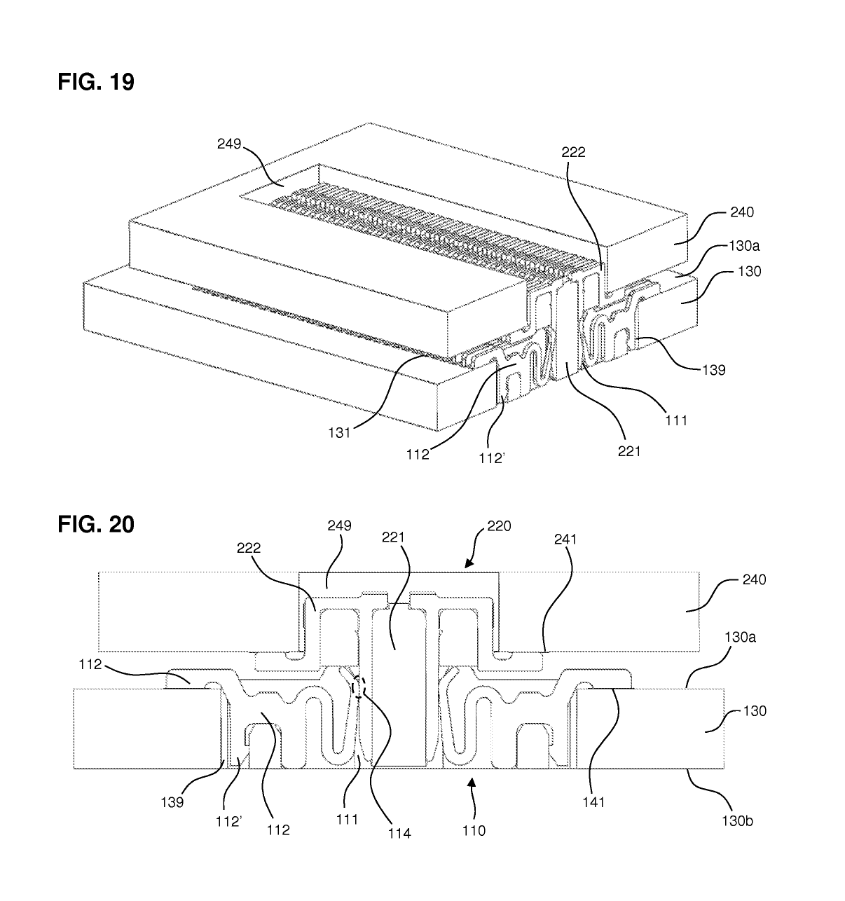

FIGS. 12-20 show a connector 200 in accordance with a second preferred embodiment of the present invention. FIGS. 12-14 are perspective views and a cross-sectional perspective view of the connector 200, which includes the socket 110 and a terminal 220 that are respectively connected to the first substrate 130 and a second substrate 240. FIG. 15 is a cross-sectional perspective view of the socket 110 and the terminal 220 shown in FIGS. 12-14 being respectively inserted into the first substrate 130 and the second substrate 240. FIG. 16 is a cross-sectional end view of the socket 110, the terminal 220, the first substrate 130, and the second substrate 240. FIGS. 17-20 are perspective views and cross-sectional views of the socket 110, the terminal 220, the first substrate 110, and the second substrate 240, when the terminal 220 is mated with the socket 110 at a first surface 130a of the first substrate 130.

As shown in FIGS. 12-20, the connector 200 according to a second preferred embodiment of the present invention includes the socket 110 connected to the substrate 130, as described above with respect to FIGS. 1-11. The terminal 220 of the connector 200 includes terminal contacts 222 that are respectively attached to connection pads of 241 of the second substrate 240. Preferably, the terminal contacts 222 are each respectively arranged in two rows that are parallel or substantially parallel, within manufacturing tolerances, with respect to each other. The terminal contacts 222 are preferably connected to their respective connection pads 241 by a fusible material, such as solder. As an example, a reflow solder operation may be used to connect the socket contacts 112 and the terminal contacts 222 to their respective connection pads 131 and 241. Preferably, the socket contacts 112 and the terminal contacts 222 are fused to their respective connection pads 131 and 241 in separate operations, prior to the terminal 220 being mated with the socket 110. However, the socket contacts 112 and the terminal contacts 222 may instead be fused to their respective connection pads 131 and 241 at the same time or in sequential operations while the terminal 220 is mated with the socket 110.

Portions of the terminal contacts 222 that are arranged to connect to the connection pads 241 may include ribbed or multi-planar shapes (not shown) to help prevent the flow of the fusible material into a wipe area of the receptacle contacts 112 where contact points 114 of the socket contacts 112 touch the corresponding ones of the terminal contacts 222 when the terminal 220 is mated with the socket 110.

The pass-through hole 111 of the socket 110 is arranged to receive a beam 221 of the terminal 220 when the terminal 220 is inserted into the socket 110. Preferably, the beam 221 does not protrude past a plane defined by a second surface 130b of the first substrate 130 when the terminal 220 is mated with the socket 110, as shown in FIG. 20. However, the beam 221 may alternatively be arranged to pass fully through the first substrate, for example, to additionally connect to another socket connector (not shown). Preferably, a distal surface of the beam 221 that is farthest away from the second substrate 240 is co-planar or substantially co-planar, within manufacturing tolerances, to the second surface 130b of the first substrate 130. The socket contacts 112 are exposed at the pass-through hole 111, and the terminal contacts 222 are exposed at the beam 221. Thus, the socket contacts 112 and the terminal contacts 222 are connected when the beam 221 is inserted into the pass-through hole 111.

As shown in FIGS. 12-20, the above-described arrangement of the socket 110 and the terminal 220 provides a stable physical and electrical connection between the socket 110 and the terminal 220.

Furthermore, the above-described arrangement of the socket 110 and the terminal 220 provides a long wipe distance between the socket contacts 112 and the terminal contacts 222, thereby cleaning oxides and other substances from the socket contacts 112 and the terminal contacts 222 when the terminal 220 is inserted into the socket 110. More specifically, the wipe distance indicates the distance along which the contact points 114 of the socket contacts 112 slide along the terminal contacts 122 when the terminal 220 is mated with the socket 110. Accordingly, an improved mechanical and electrical connection between the socket contacts 112 and the terminal contacts 222 is achieved.

As described above with respect to FIGS. 2-5 and 7-11, and as also shown in FIGS. 12-20, the socket 110 is configured to fit into a cut-out 139 of the first substrate 130. Furthermore, as shown in FIGS. 12-20, the terminal 220 is also configured to fit into a cut-out 249 of the second substrate 240. Accordingly, since the socket 110 is recessed within the cut-out 139 of the first substrate 130, the beam 221 of the terminal 220 passes through a plane defined by the first surface 130a of the first substrate 130 when the terminal 220 is mated with the socket 110. Thus, when the terminal 220 is fully mated with the socket 110, as shown in FIGS. 17-20, only a small spacing exists between the first substrate 130 and the second substrate 240.

Further, because the terminal 220 is also recessed within the cut-out 249 of the second substrate 240, the spacing between the first substrate 120 and the second substrate 240 is smaller than the spacing between the first substrate 130 and the second substrate 140 shown in FIGS. 6-9.

The above-described arrangement of the socket 110 and the terminal 220 provides a small spacing between the first substrate 130 and the second substrate 240, thus allowing a denser arrangement of substrates when the terminal 220 is fully mated with the socket 110 as shown in FIGS. 17-20.

As shown in FIGS. 16 and 20, the positions of the contact points 114 of the socket contacts 112 move due to a deflection in the socket contacts 112 that occurs as a result of the contact points 114 pressing against the terminal contacts 222 when the terminal 220 is inserted into the socket 110.

Further, according to a preferred embodiment of the present invention, the contact point 114 may be located near the midpoint between the first and second surfaces 130a and 130b of the first substrate 130 in order to provide a moderate force for retaining the terminal 220 in the socket 110 regardless of the direction that the terminal 220 is inserted into the socket 110. Additionally, if the contact point 114 is located near the midpoint between the first and second surfaces 130a and 130b of the first substrate 130, the wipe distance between the socket contacts 112 and the terminal contacts 222 may be about the same regardless of the direction that the terminal 220 is inserted into the socket 110.

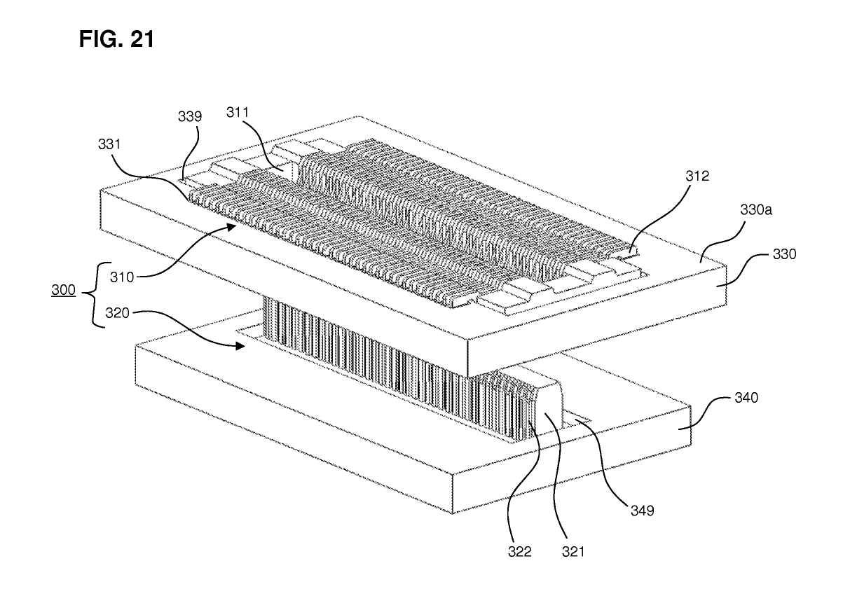

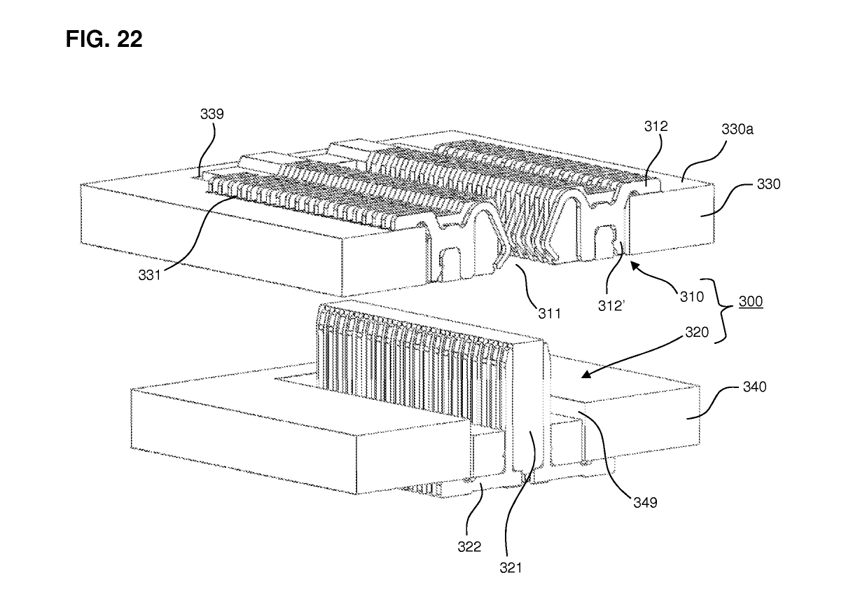

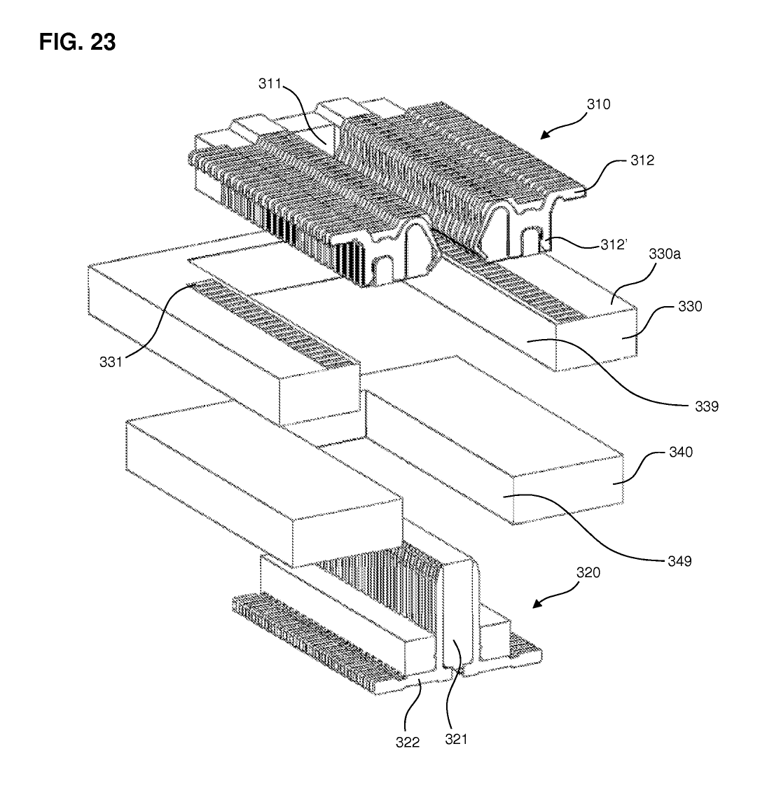

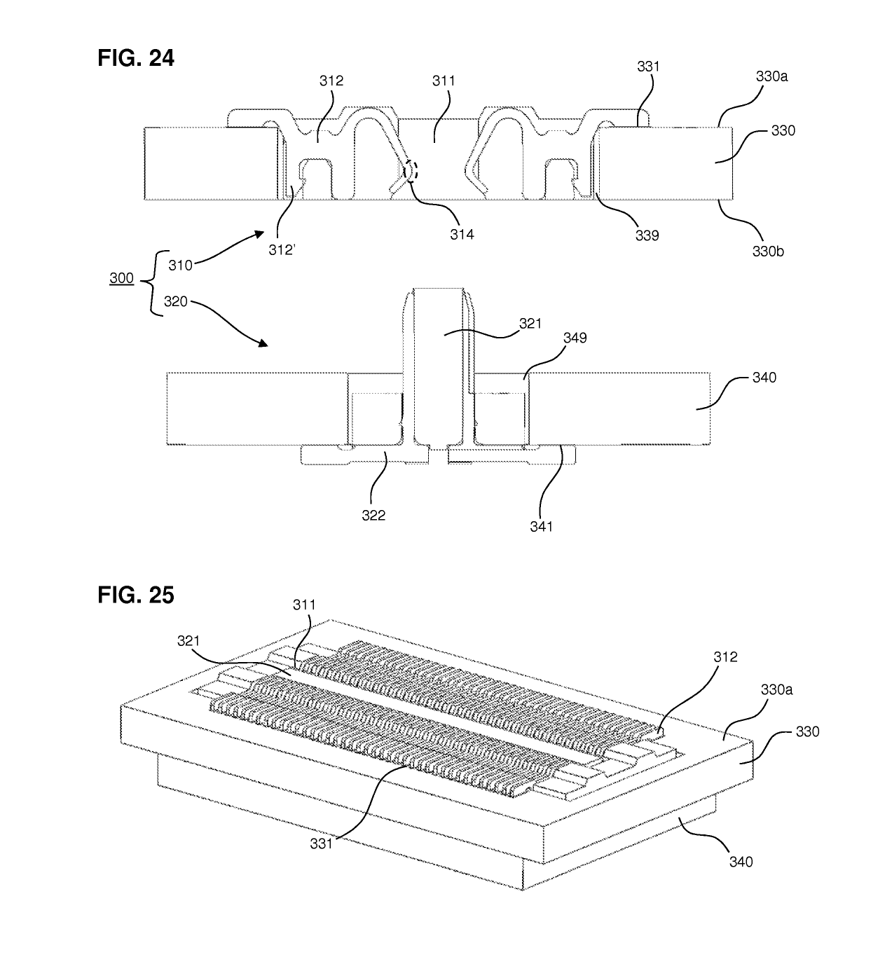

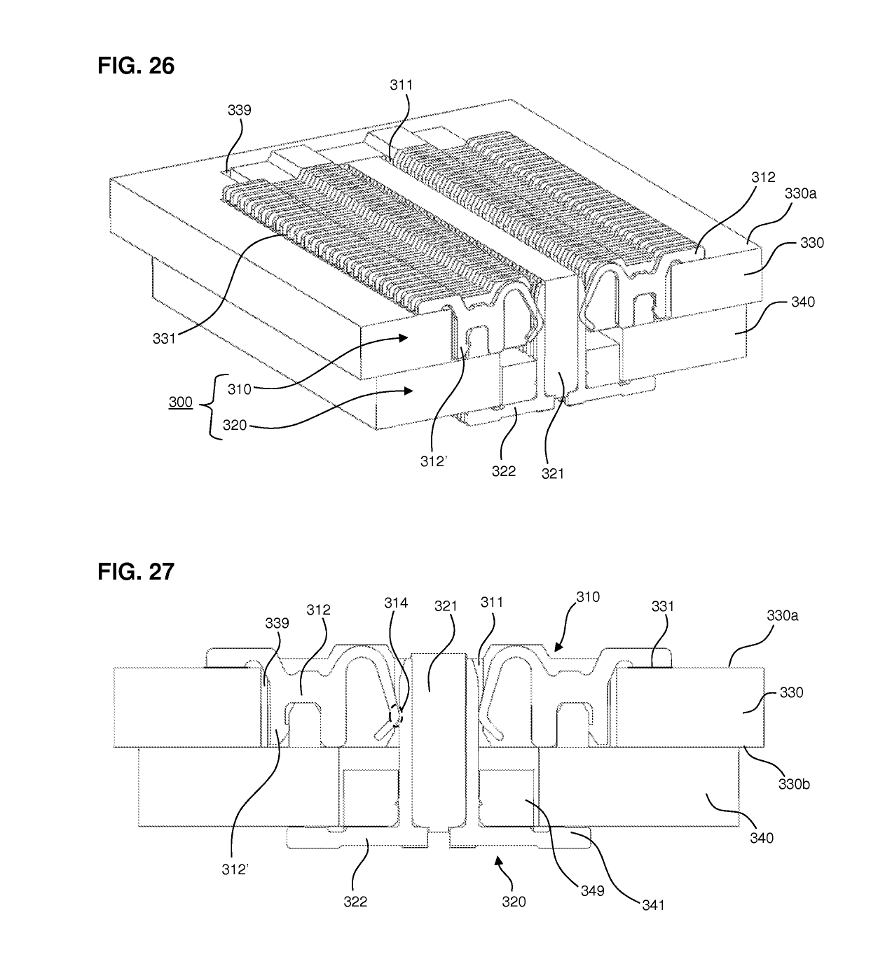

FIGS. 21-27 show a connector 300 in accordance with a third preferred embodiment of the present invention. FIGS. 21 and 22 are a perspective view and a cross-sectional perspective view of the connector 300, which includes a socket 310 and a terminal 320 that are respectively connected to a first substrate 330 and a second substrate 340. FIG. 23 is a cross-sectional perspective view of the socket 310 and the terminal 320 shown in FIGS. 21 and 22 being respectively inserted into the first substrate 330 and the second substrate 340 shown in FIGS. 21 and 22. FIG. 24 is a cross-sectional end view of the socket 310, the terminal 320, the first substrate 330, and the second substrate 340 shown in FIGS. 21 and 22. FIGS. 25-27 are a perspective view and cross-sectional views of the socket 310, the terminal 320, the first substrate 330, and the second substrate 340 shown in FIGS. 21 and 22, when the terminal 320 is mated with the socket 310.

As shown in FIGS. 21-27, the socket 310 includes socket contacts 312 that are respectively connected to connection pads 331 of the first substrate 330, and the terminal 320 includes terminal contacts 322 that are respectively attached to connection pads of 341 of the second substrate 340. Preferably, the socket contacts 312 and the terminal contacts 322 are each respectively arranged in two corresponding rows that are parallel or substantially parallel, within manufacturing tolerances, with respect to each other. The socket contacts 312 and the terminal contacts 322 are preferably connected to their respective connection pads 331 and 341 by a fusible material, such as solder. As an example, a reflow solder operation may be used to connect the socket contacts 312 and the terminal contacts 322 to their respective connection pads 331 and 341. Preferably, the socket contacts 312 and the terminal contacts 322 are fused to their respective connection pads 331 and 341 in separate operations, prior to the terminal 320 being mated with the socket 310. However, the socket contacts 312 and the terminal contacts 322 may instead be fused to their respective connection pads 331 and 341 at the same time or in sequential operations while the terminal 320 is mated with the socket 310.

Portions of the socket contacts 312 and the terminal contacts 322 that are arranged to connect to the connection pads 331 and 341 may include ribbed or multi-planar shapes (not shown) to help prevent the flow of the fusible material into a wipe area of the receptacle contacts 312 where contact points 314 of the socket contacts 312 touch the corresponding ones of the terminal contacts 322 when the terminal 320 is mated with the socket 310. Further, the fusible material may flow to retaining arms 312′ of the socket contacts 312 that are press-fit into corresponding holes in the socket 310, thereby helping secure the socket contacts 312 to the socket 310 and preventing the fusible material from flowing to the wipe area and contact points 314 of the socket contacts 312.

The socket 310 includes a pass-through hole 311 arranged to receive a beam 321 of the terminal 320 when the terminal 320 is inserted into the socket 310. Preferably, the beam 321 does not protrude past an outer surface of the socket 310 when the terminal 320 is mated with the socket 310, as shown in FIG. 27. However, the beam 321 may alternatively be arranged to pass fully through the socket 310, for example, to additionally connect to another socket connector (not shown). Preferably, a distal surface of the beam 321 that is farthest away from the second substrate 340 is co-planar or substantially co-planar, within manufacturing tolerances, to the first surface 330a of the first substrate 330. The socket contacts 312 are exposed at the pass-through hole 311, and the terminal contacts 322 are exposed at the beam 321. Thus, the socket contacts 312 and the terminal contacts 322 are connected when the beam 321 is inserted into the pass-through hole 311.

As shown in FIGS. 21-27, the above-described arrangement of the socket 310 and the terminal 320 provides a stable physical and electrical connection between the socket 310 and the terminal 320.

Furthermore, the above-described arrangement of the socket 310 and the terminal 320 provides a long wipe distance between the socket contacts 312 and the terminal contacts 322, thereby cleaning oxides and other substances from the socket contacts 312 and the terminal contacts 322 when the terminal 320 is inserted into the socket 310. More specifically, the wipe distance indicates the distance along which the contact points 314 of the of the socket contacts 312 slide along the terminal contacts 322 when the terminal 320 is mated with the socket 310. Accordingly, an improved mechanical and electrical connection between the socket contacts 312 and the terminal contacts 322 is achieved.

As shown in FIGS. 21-27, the socket 310 is configured to fit into a cut-out 339 of the first substrate 330. Furthermore, as shown in FIGS. 21-27, the terminal 320 is also configured to fit into a cut-out 349 of the second substrate 340. Accordingly, since the socket 310 is recessed within the cut-out 339 of the first substrate 330, the beam 321 of the terminal 320 passes through a plane defined by the second surface 330b of the first substrate 330 when the terminal 320 is mated with the socket 310. Further, because the connection pads 331 of the first substrate 330 and the connection pads 341 of the second substrate 340 are arranged on non-facing major planar surfaces of the first substrate 330 and the second substrate 340, no portion of the connector 300 is arranged between the facing major planar surfaces of the first substrate 330 and the second substrate 340 when the terminal 320 is mated with the socket 310, except for the beam 321 and the terminal contacts 322. Thus, when the terminal 320 is fully mated with the socket 310, as shown in FIGS. 25-27, no spacing or substantially no spacing, within manufacturing tolerances, exists between the first substrate 330 and the second substrate 340. However, if other components are mounted on the facing surfaces of the first substrate 330 and the second substrate 340, then the components can interfere with the first substrate 330 and the second substrate 340 fully mating such that the first substrate 330 and the second substrate 340 are separated by the height of the components.

As compared with the spacing between the first substrate 130 and the second substrate 140 as shown in FIGS. 6-9, and the spacing between the first substrate 130 and the second substrate 240 as shown in FIGS. 17-20, the spacing between the first substrate 330 and the second substrate 340 as shown in FIGS. 25-27 is reduced even more because the joints between the contacts 312, 322 and the connection pads 331, 341 are not included between the first substrate 330 and the second substrate 340.

As shown in FIGS. 24 and 27, the positions of the contact points 314 of the socket contacts 312 move due to a deflection in the socket contacts 312 that occurs as a result of the contact points 314 pressing against the terminal contacts 322 when the terminal 320 is inserted into the socket 310.

According to a preferred embodiment of the present invention, the contact point 314 may be located near the midpoint between the major planar surfaces of the first substrate in order to provide a moderate force for retaining the terminal 320 in the socket 310 regardless of the direction that the terminal 320 is inserted into the socket 310. Additionally, if the contact point 314 is located near the midpoint between the first and second surfaces 330a and 330b of the first substrate 330, the wipe distance between the socket contacts 312 and the terminal contacts 322 may be about the same regardless of the direction that the terminal 320 is inserted into the socket 310.

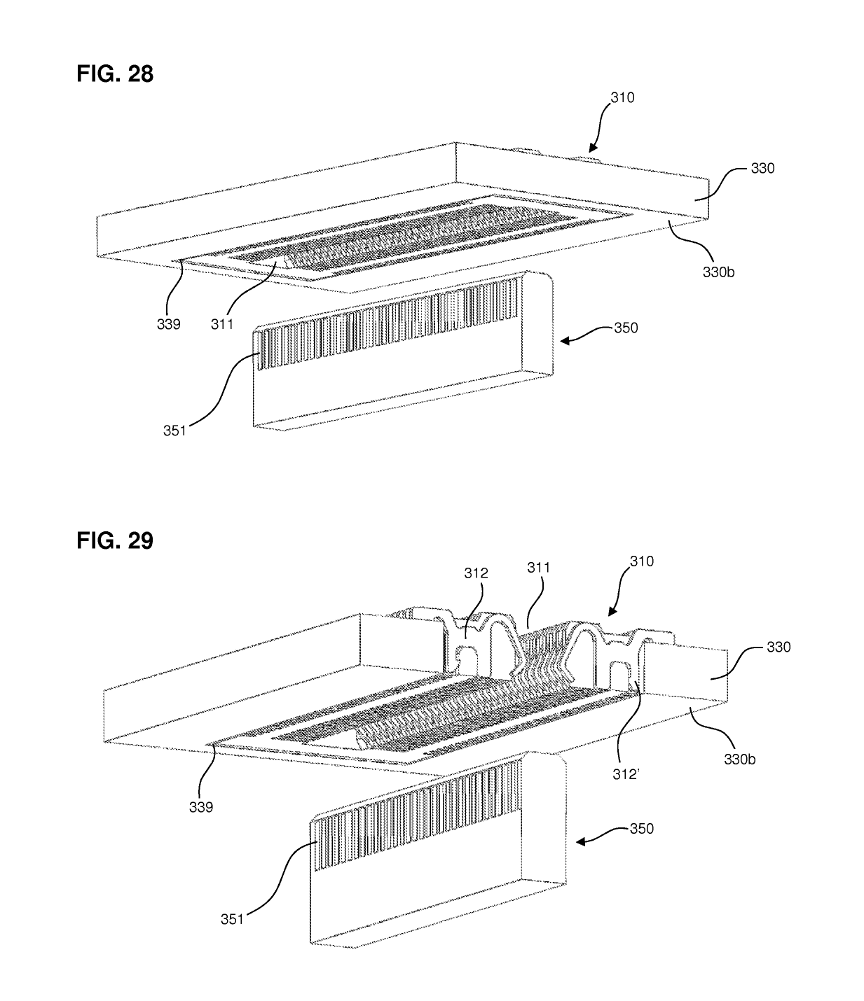

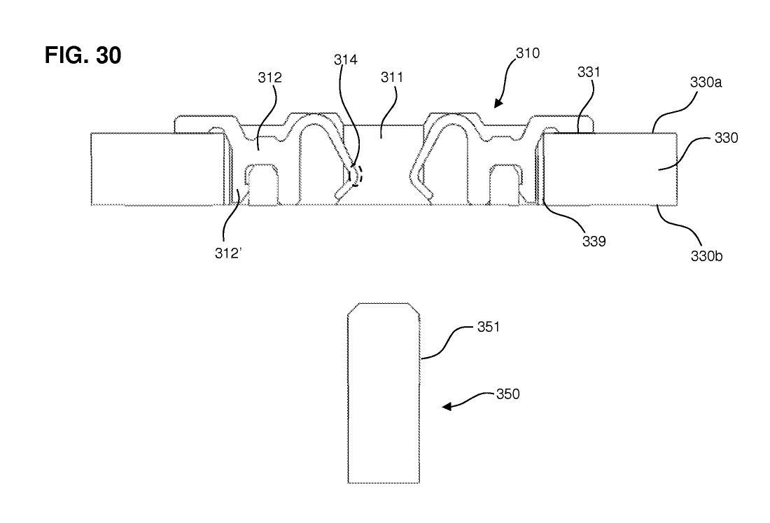

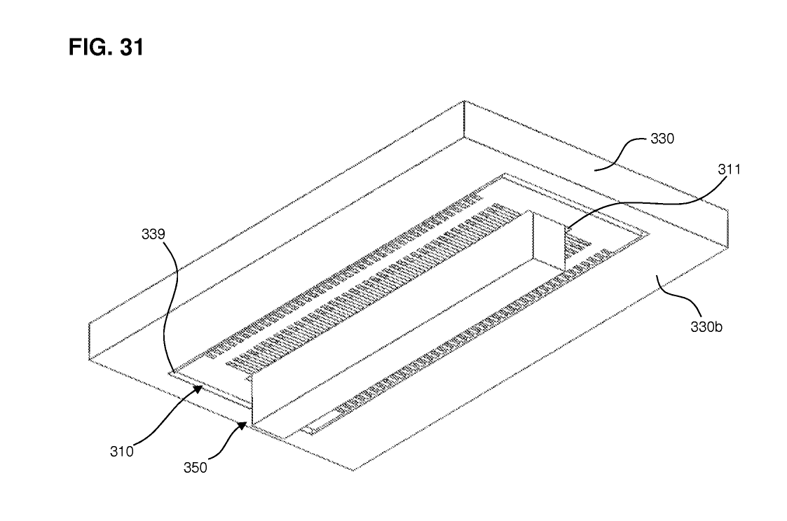

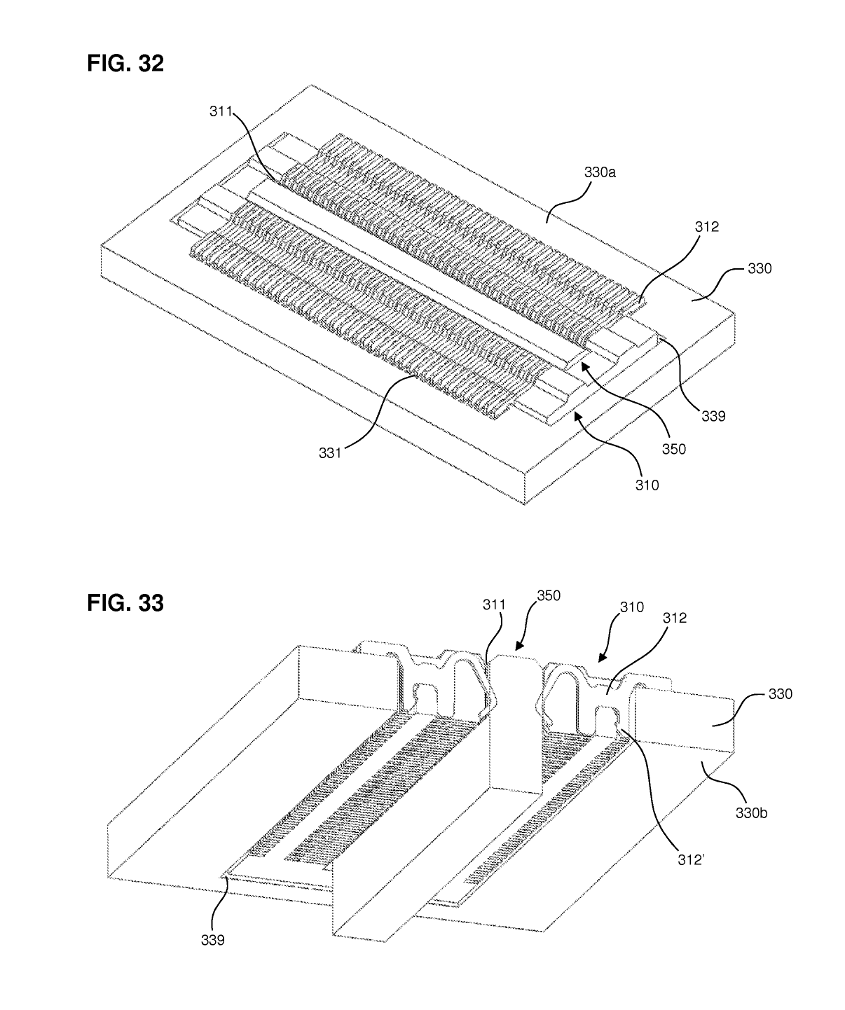

FIGS. 28-33 show an edge card 350 arranged to connect with the socket 310 in accordance with a fourth preferred embodiment of the present invention. FIGS. 28 and 29 are a perspective view and a cross-sectional perspective view of the edge card 350, the socket 310, and the first substrate 330 shown in FIGS. 21 and 22. FIG. 30 is a cross-sectional end view of the edge card 350, the socket 310, and the first substrate 330 shown in FIGS. 28 and 29. FIGS. 31-33 are perspective views and a cross-sectional perspective view of edge card 350, the socket 310, and the first substrate 330 shown in FIGS. 28 and 29, when the edge card 350 is mated with the socket 310.

As shown in FIGS. 28-33, the edge card 350 may be inserted into the socket 310 shown in FIGS. 21-27 in place of the terminal 320. As shown in FIGS. 28-30 and 33, the edge card 350 includes connection pads 351 arranged at an edge thereof. As described above and as shown in FIGS. 28-30 and 33, the socket contacts 312 are exposed at the pass-through hole 311, such that the socket contacts 312 and the connection pads 351 of the edge card 350 are connected when the edge card 350 is inserted into the pass-through hole 311 and mated with the socket 310. Preferably, the major planar surfaces of the edge card 350 are perpendicular or substantially perpendicular, within manufacturing tolerances, to the first and second surfaces 330a and 330b of the first substrate 330.

The edge card 350 can include a shoulder portion (not shown) that comes into contact with at least one of the socket 310 and the first substrate 330 when the edge card 350 is mated with the socket 310. The shoulder portion is preferably configured so that the connection pads 351 of the edge card 350 align with respective ones of the socket contacts 312 when the edge card 350 is fully inserted into the socket 310. Accordingly, the shoulder portion prevents the edge card 350 from being inserted too far into the socket 310. However, the shoulder portion of the edge card 350 may not be included, for example, to allow the edge card 350 to be insertable into the socket 310 at either the first surface 330a or the second surface 330b of the first substrate 330 with sufficient wipe distance.

According to a preferred embodiment of the present invention, the connection pads 351 of the edge card 350 may be arranged at a distance from the edge of the edge card 350, such that a portion of the edge card 350 passes fully through the socket 310 and the first substrate 330, for example, to additionally connect to another socket connector (not shown).

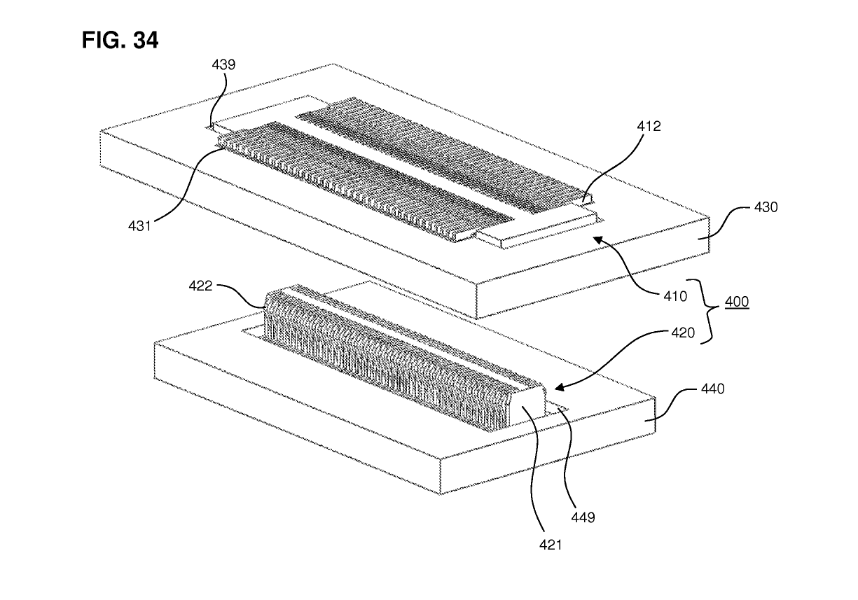

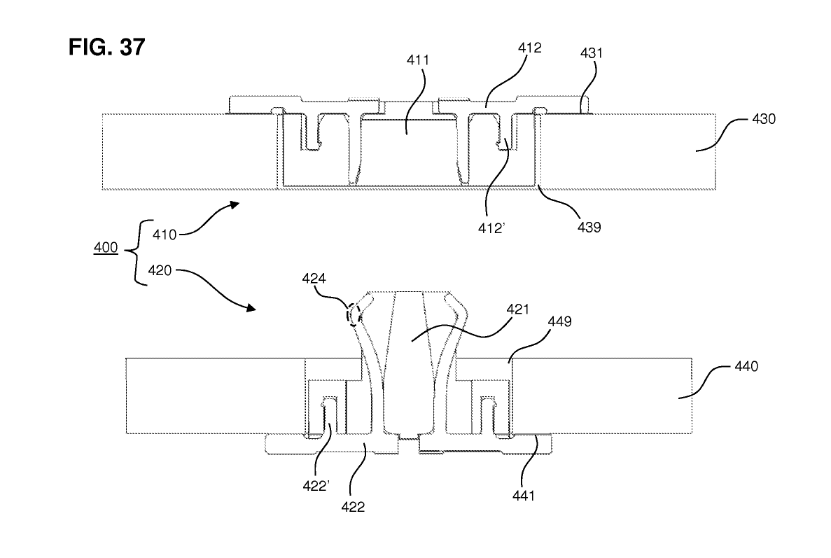

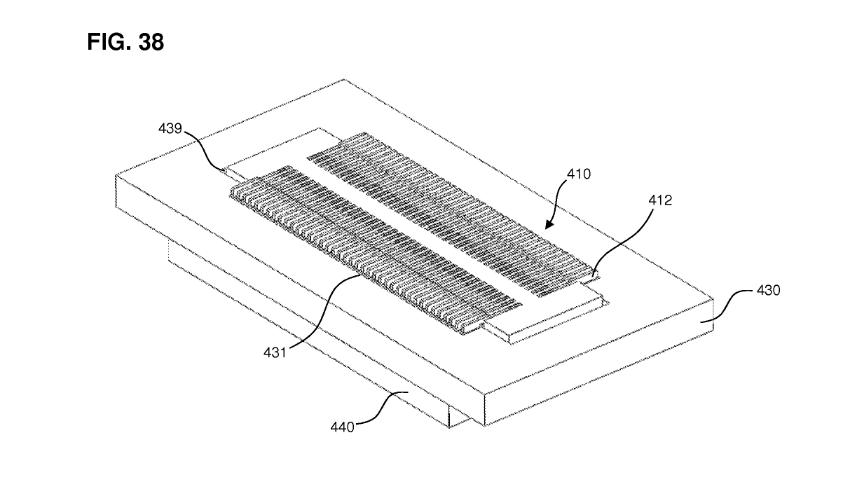

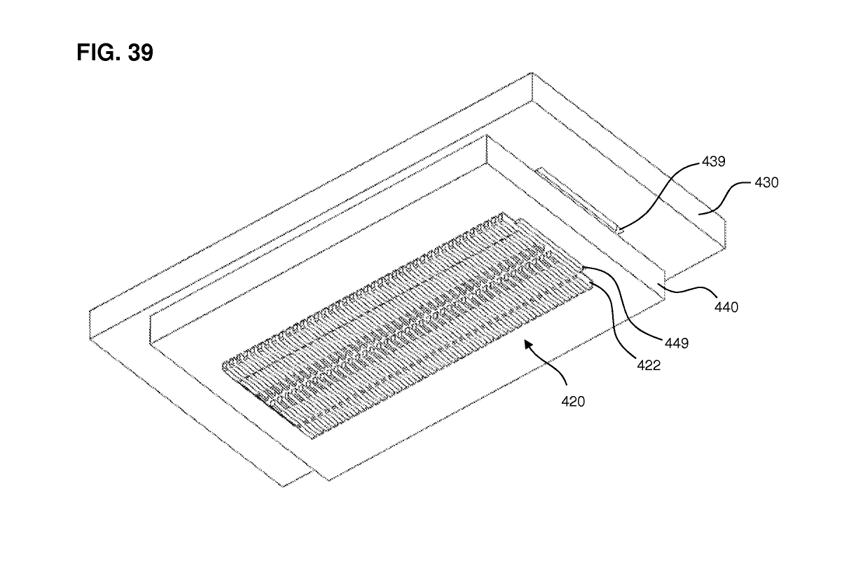

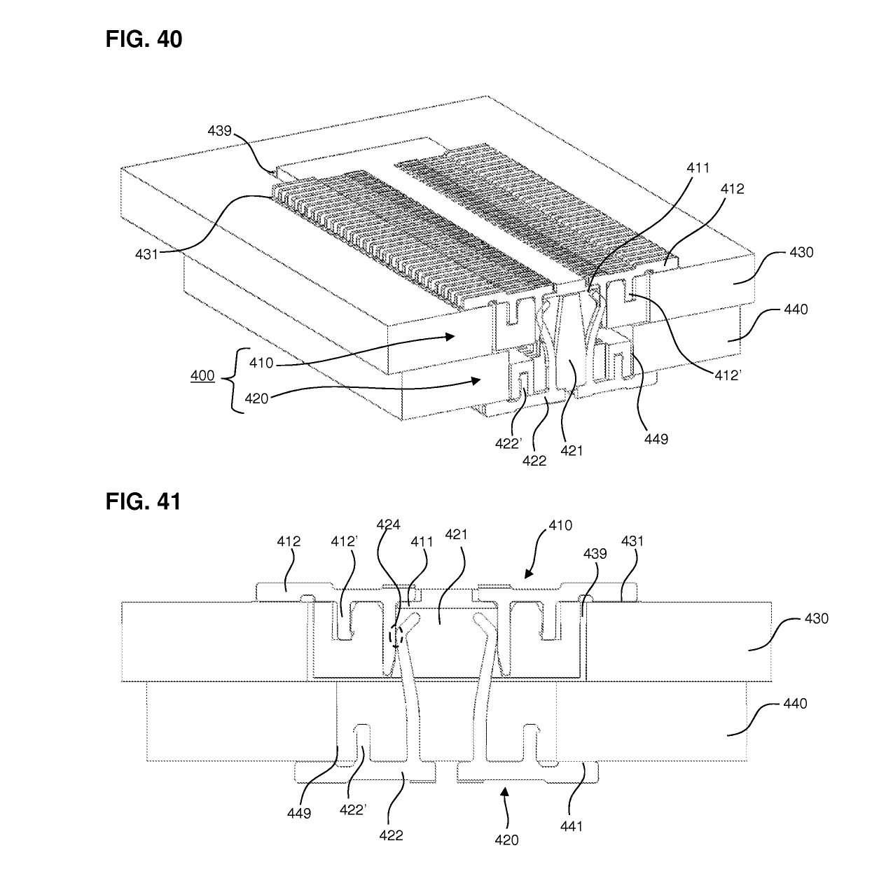

FIGS. 34-41 show a connector 400 in accordance with a fifth preferred embodiment of the present invention. FIG. 34-36 are perspective views and a cross-sectional perspective view of the connector 400, which includes a socket 410 and a terminal 420 that are respectively connected to a first substrate 430 and a second substrate 440. FIG. 37 is a cross-sectional end view of the socket 410, the terminal 420, the first substrate 430, and the second substrate 440 shown in FIGS. 34-36. FIG. 38-41 are perspective views and cross-sectional views of the socket 410, the terminal 420, the first substrate 430, and the second substrate 440 shown in FIGS. 34-36, when the terminal 420 is mated with the socket 410.

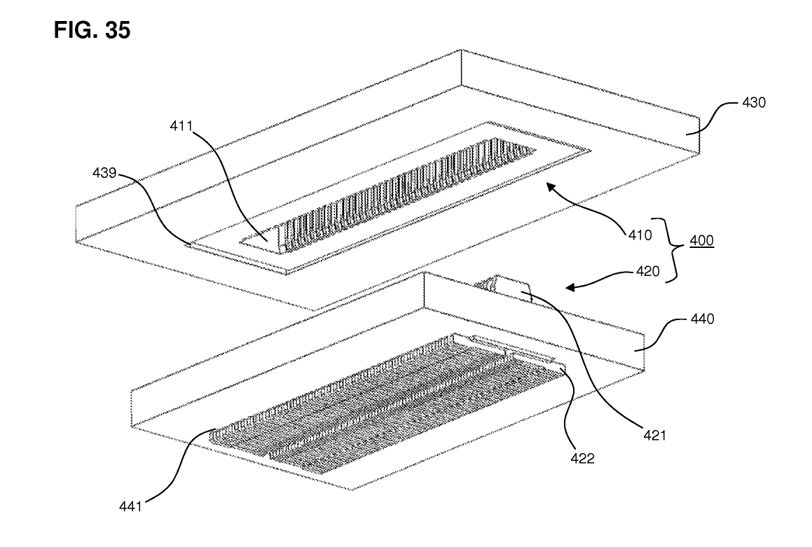

As shown in FIGS. 34-41, the socket 410 includes socket contacts 412 that are respectively connected to connection pads 431 of the first substrate 430, and the terminal 420 includes terminal contacts 422 that are respectively attached to connection pads of 441 of the second substrate 440. Preferably, the socket contacts 412 and the terminal contacts 422 include respective retaining arms 412′ and 422′ that are press-fit into corresponding holes in the socket 410 and the terminal 420 to help secure the socket contacts 412 to the socket 410 and the terminal contacts 422 to the terminal 420. As shown in FIGS. 35-37, 40, and 41, the socket 410 includes a recess 411 arranged to receive a beam 421 of the terminal 420 when the terminal 420 is inserted into the socket 410. As shown in FIGS. 34-41, the socket 410 is configured to fit into a cut-out 439 of the first substrate 430, and the terminal 420 is configured to fit into a cut-out 449 of the second substrate 440.

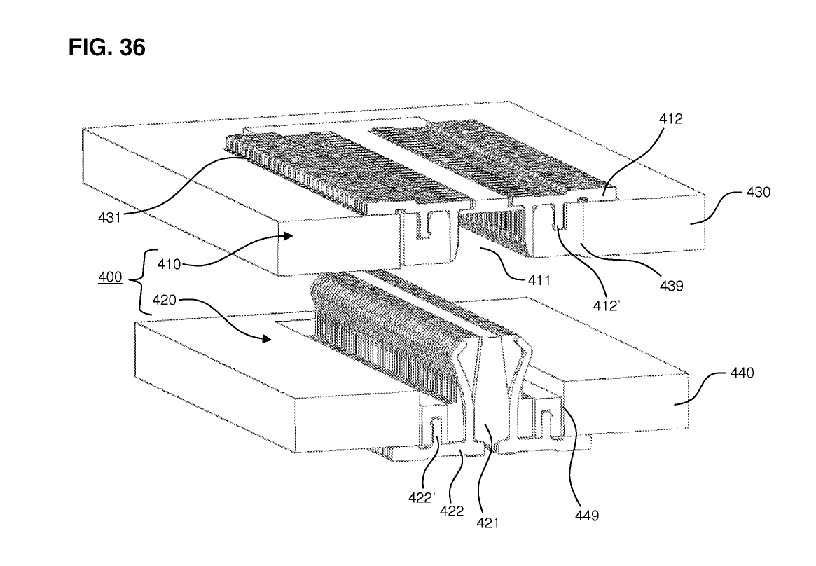

The socket 410, the terminal 420, the first substrate 430, and the second substrate 440 as shown in FIGS. 34-41 preferably are similar to the socket 310, the terminal 320, the first substrate 330, and the second substrate 340 as shown in FIGS. 21-27. However, as shown in FIGS. 36, 37, 40, and 41, the contact points 424 of the connector 400 are arranged on terminal contacts 422. That is, in contrast to the contact points 114 and 314 of the first, second, third, and fourth preferred embodiments, which are arranged on socket contacts 112 and 312, the contact points 424 of the connector 400 are instead arranged on terminal contacts 422 as shown in FIGS. 36, 37, 40, and 41. Thus, because the socket contacts 412 do not include the various bent portions that form the contact points 114 and 314 on the socket contacts 112 and 312, the socket contacts 412 do not deflect when the terminal 420 is mated with the socket 410 (instead, the terminal contacts 422 deflect). Accordingly, because of the lack of bent portions and of deflection in the socket contacts 412, the socket contacts 412 provide increased reliability and longevity as compared with the socket contacts 112 and 113. Thus, the socket 410 is preferably used, for example, if a specific application requires a socket of a connector that is able to repeatedly mate and un-mate with one or more terminals.

As shown in FIGS. 34-41, the above-described arrangement of the socket 410 and the terminal 420 provides a stable physical and electrical connection between the socket 410 and the terminal 420.

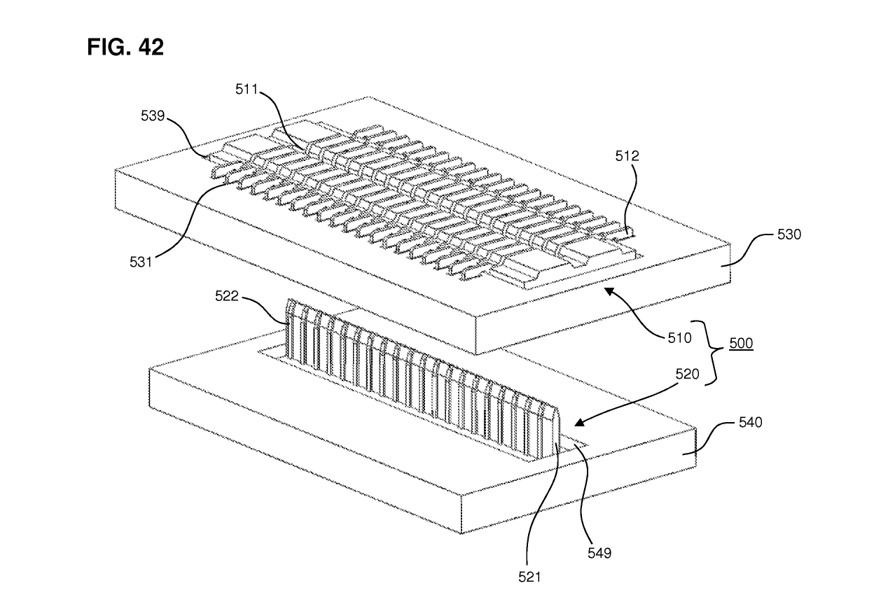

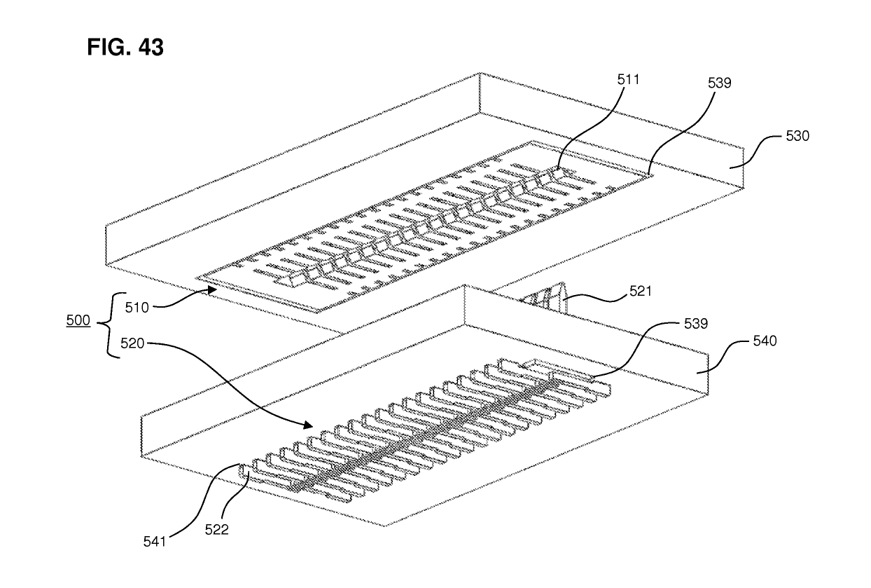

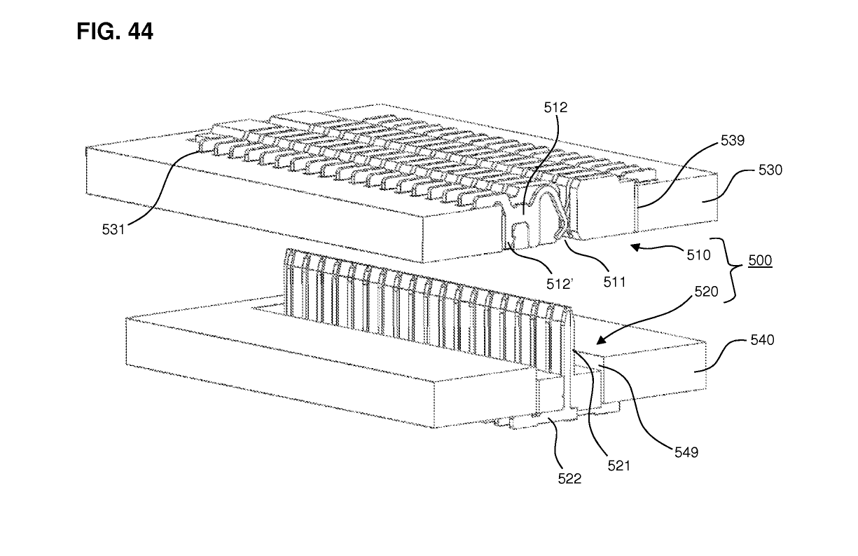

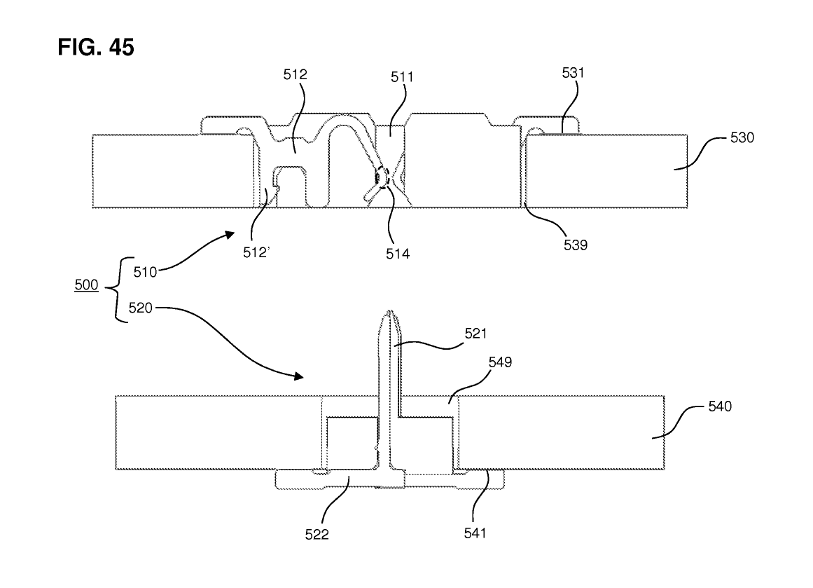

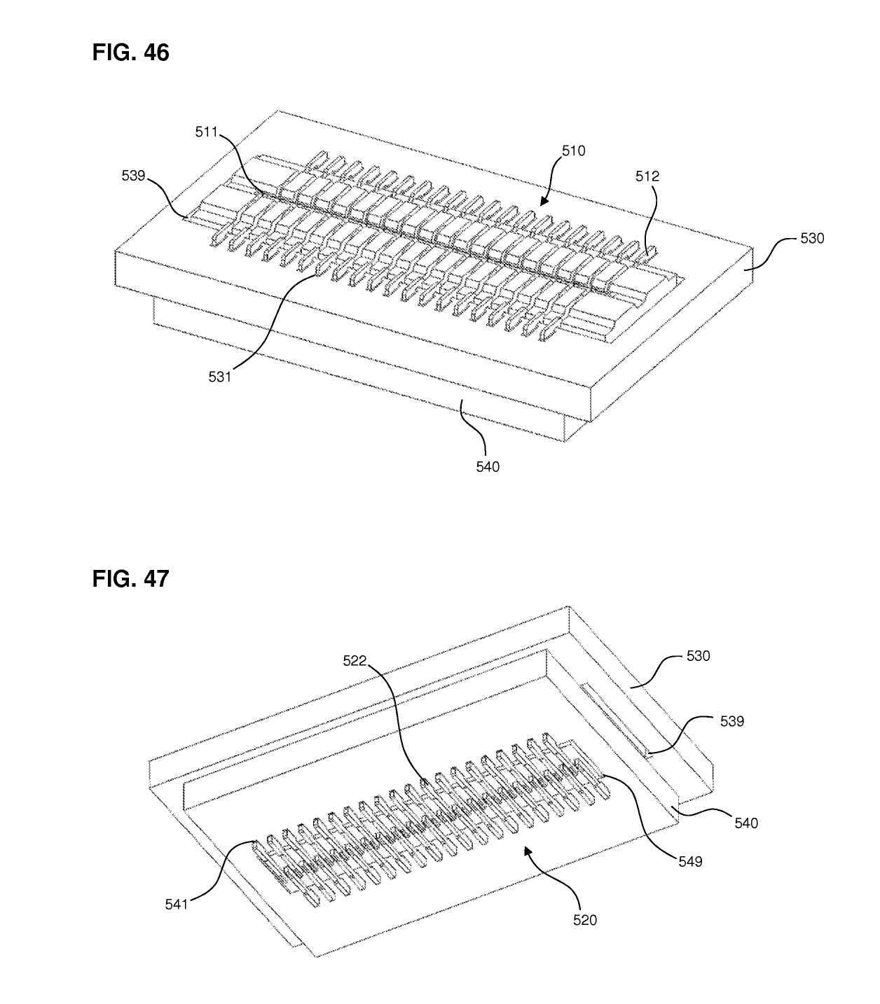

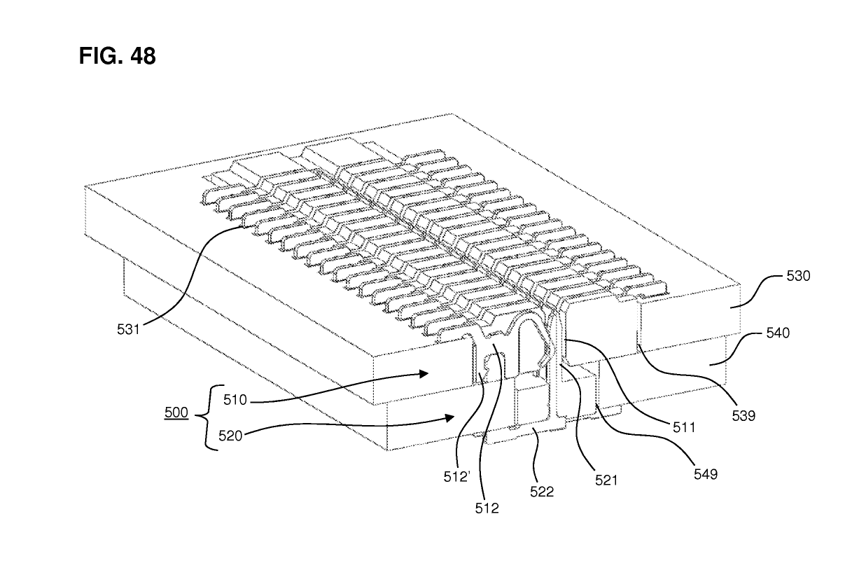

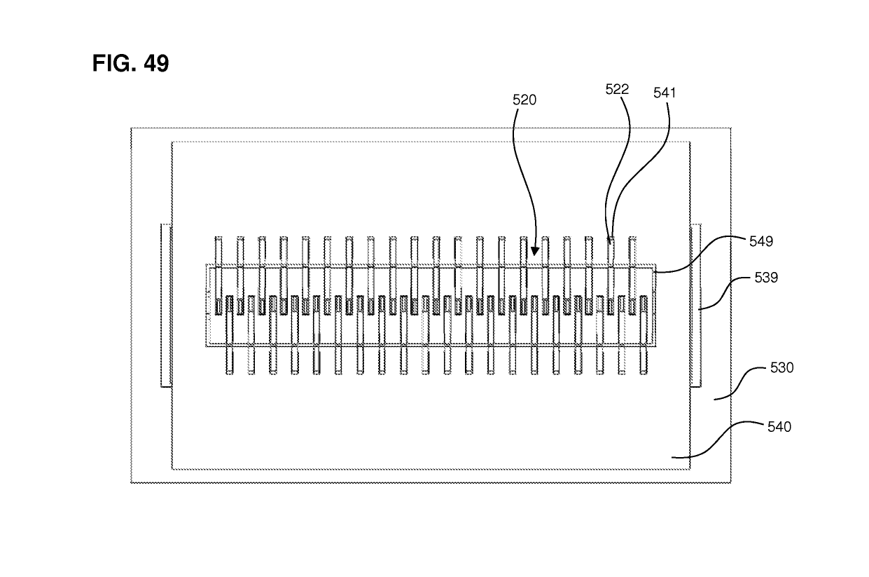

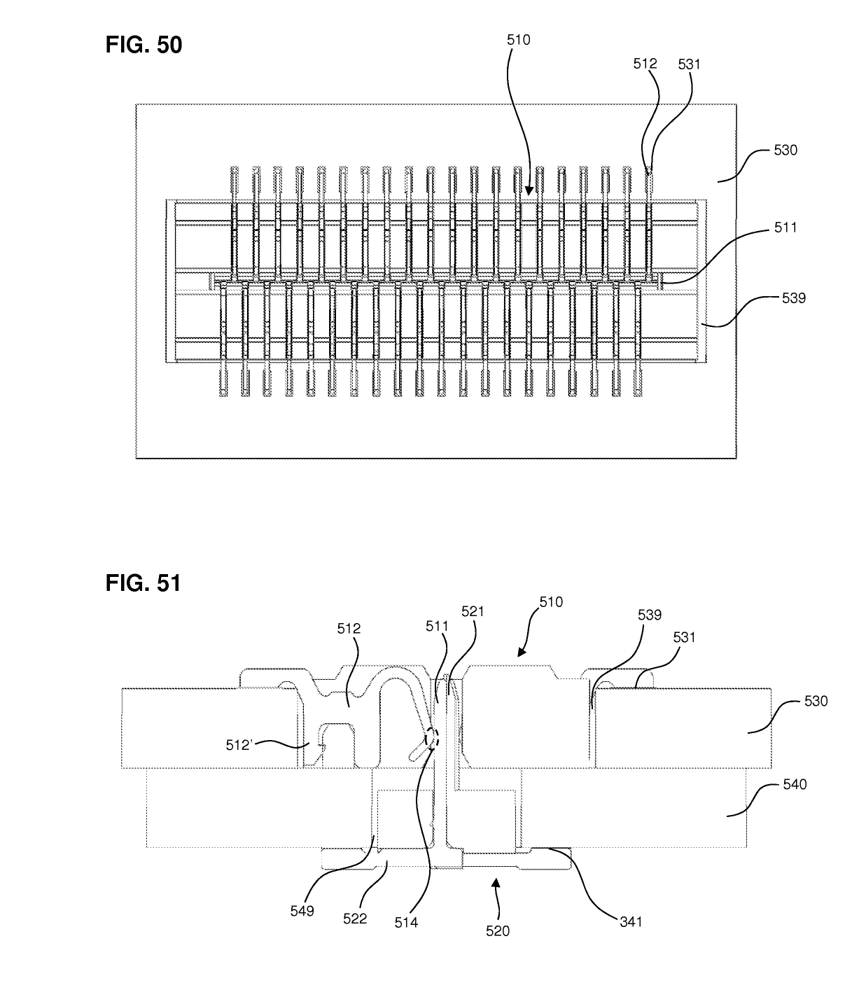

FIGS. 42-51 show a connector 500 in accordance with a sixth preferred embodiment of the present invention. FIGS. 42-44 are perspective views and a cross-sectional perspective view of the connector 500, which includes a socket 510 and a terminal 520 that are respectively connected to a first substrate 530 and a second substrate 540. FIG. 45 is a cross-sectional end view of the socket 510, the terminal 520, the first substrate 530, and the second substrate 540 shown in FIGS. 42-44. FIG. 46-48 are perspective views and a cross-sectional perspective view of the socket 510, the terminal 520, the first substrate 530, and the second substrate 540 shown in FIGS. 42-44, when the terminal 520 is mated with the socket 510. FIGS. 49 and 50 are planar views of the socket 510, the terminal 520, the first substrate 530, and the second substrate 540 shown in FIGS. 42-44. FIG. 51 is a cross-sectional end view of the socket 510, the terminal 520, the first substrate 530, and the second substrate 540 shown in FIGS. 42-44, when the terminal 520 is mated with the socket 510.

As shown in FIGS. 42-51, the socket 510 includes socket contacts 512 that are respectively connected to connection pads 531 of the first substrate 530, and the terminal 520 includes terminal contacts 522 that are respectively attached to connection pads of 541 of the second substrate 540. Preferably, the socket contacts 512 include retaining arms 512′ that are press-fit into corresponding holes in the socket 510 to help secure the socket contacts 512 to the socket 510. As shown in FIGS. 42-46, 48, and 51, the socket 510 includes a pass-through hole 511 arranged to receive a beam 521 of the terminal 520 when the terminal 520 is inserted into the socket 510. As shown in FIGS. 42-51, the socket 510 is configured to fit into a cut-out 539 of the first substrate 530, and the terminal 520 is configured to fit into a cut-out 549 of the second substrate 540.

The socket 510, the terminal 520, the first substrate 530, and the second substrate 540 as shown in FIGS. 42-51 are similar to the socket 310, the terminal 320, the first substrate 330, and the second substrate 340 as shown in FIGS. 21-27. However, as shown in FIG. 49, the two rows of terminal contacts 522 are offset with respect to each other. Correspondingly, as shown in FIG. 50, the two rows of the socket contacts 512 are offset with respect to each other. Accordingly, each of the socket contacts 512 is aligned with a respective one of the terminal contacts 522 when the terminal 520 is mated with the socket 510. As shown in FIGS. 49 and 50, the rows of connection pads 531 and 541 are offset with respect to each other in order to align with respective ones of the socket contacts 512 and the terminal contacts 522.

Furthermore, since the terminal contacts 522 are offset, a beam 521 of the terminal 520, as shown in FIGS. 42-45, 48, and 51, can be formed to be narrower than the beam 321 of the third preferred embodiment. Accordingly, offsetting the socket contacts 512 and the terminal contacts 522 allows the connector 500 to be smaller than the connector 300, and thus requires a smaller footprint on each of the first substrate 530 and the second substrate 540 than the footprint of the connector 300 on each of the first substrate 330 and the second substrate 340. Specifically, offsetting the socket contacts 512 and the terminal contacts 522 allows for a smaller pitch between the socket contacts 512 and the terminal contacts 522 and allows for a smaller dimension for the connector 500 in the lateral direction shown in the cross-sectional view of FIG. 45.

As shown in FIGS. 42-51, the above-described arrangement of the socket 510 and the terminal 520 provides a stable physical and electrical connection between the socket 510 and the terminal 520.

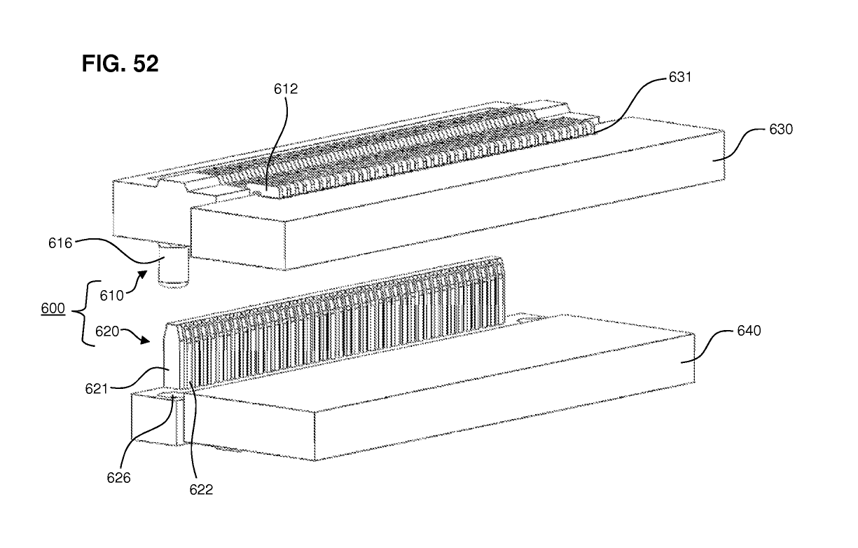

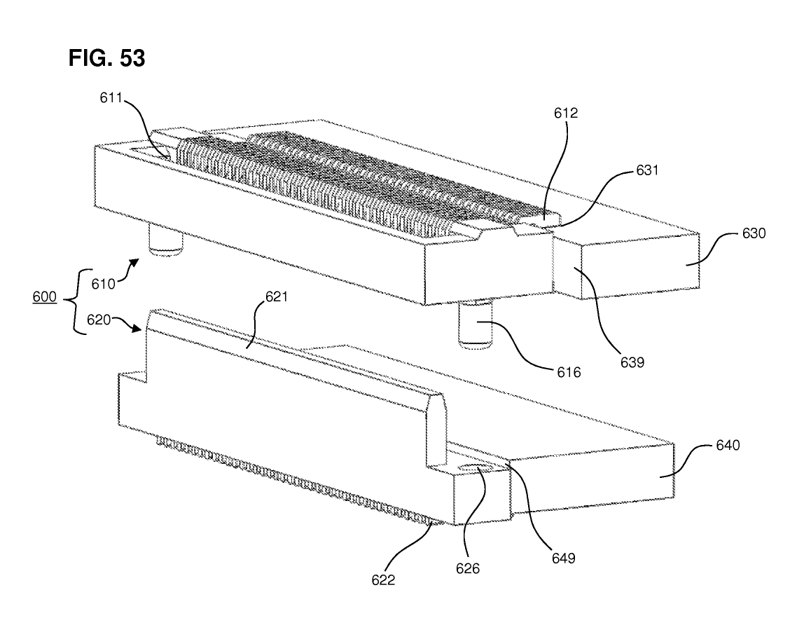

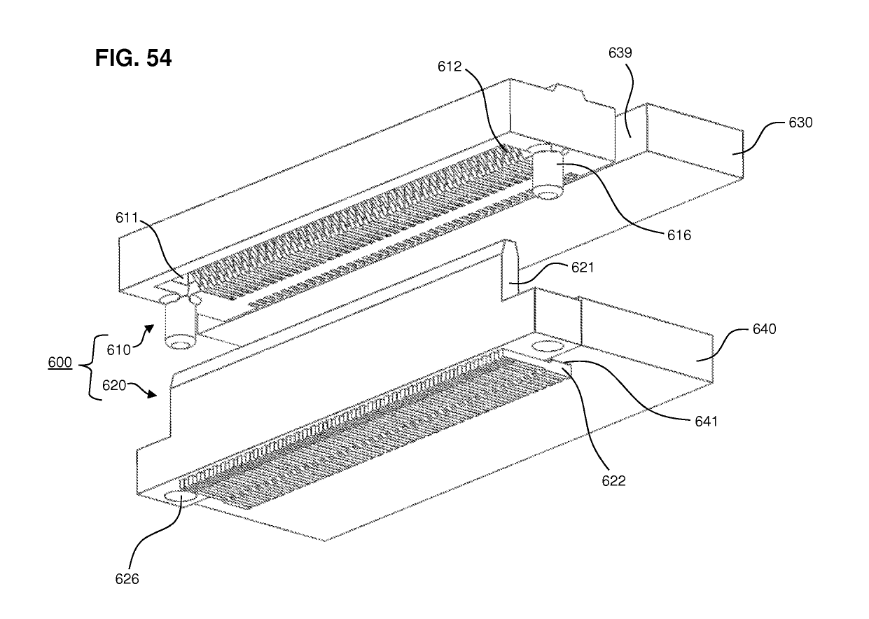

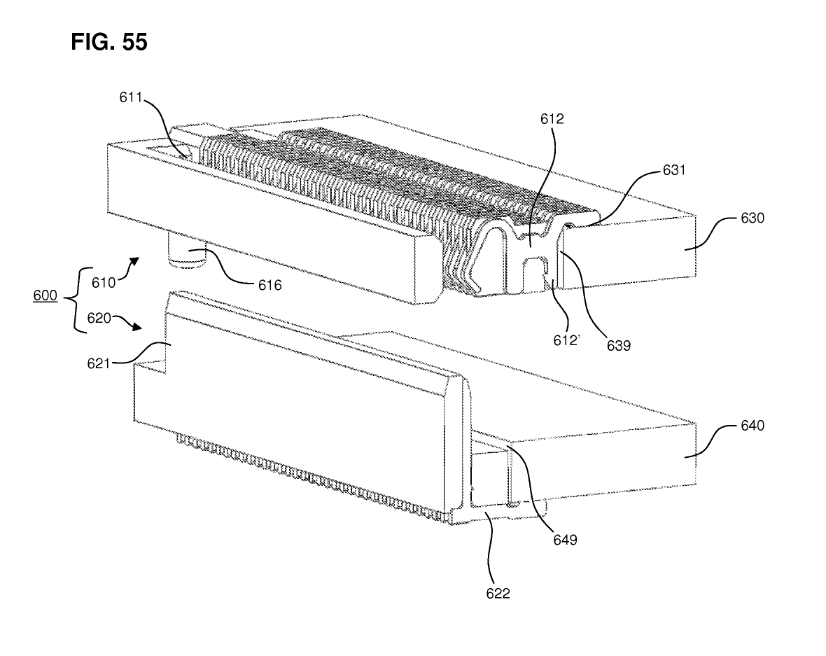

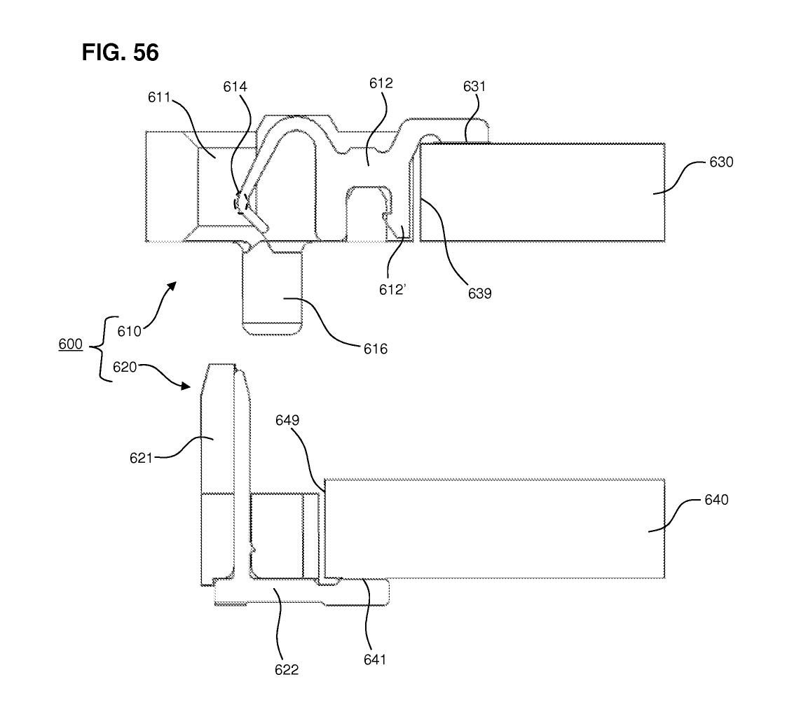

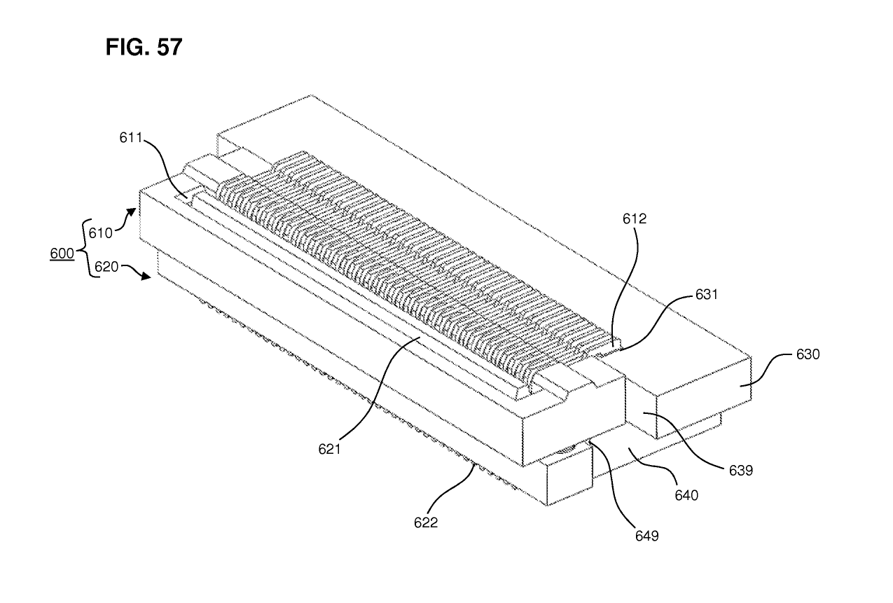

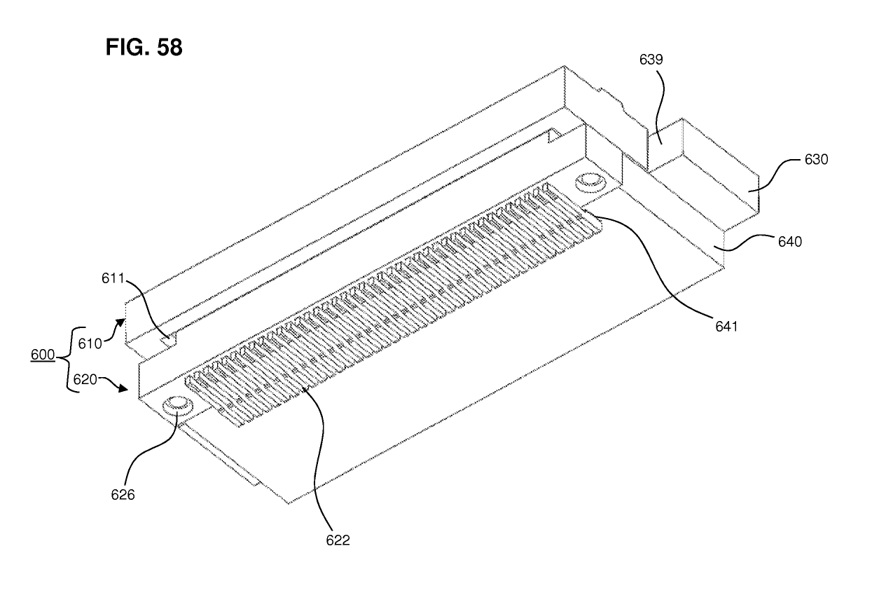

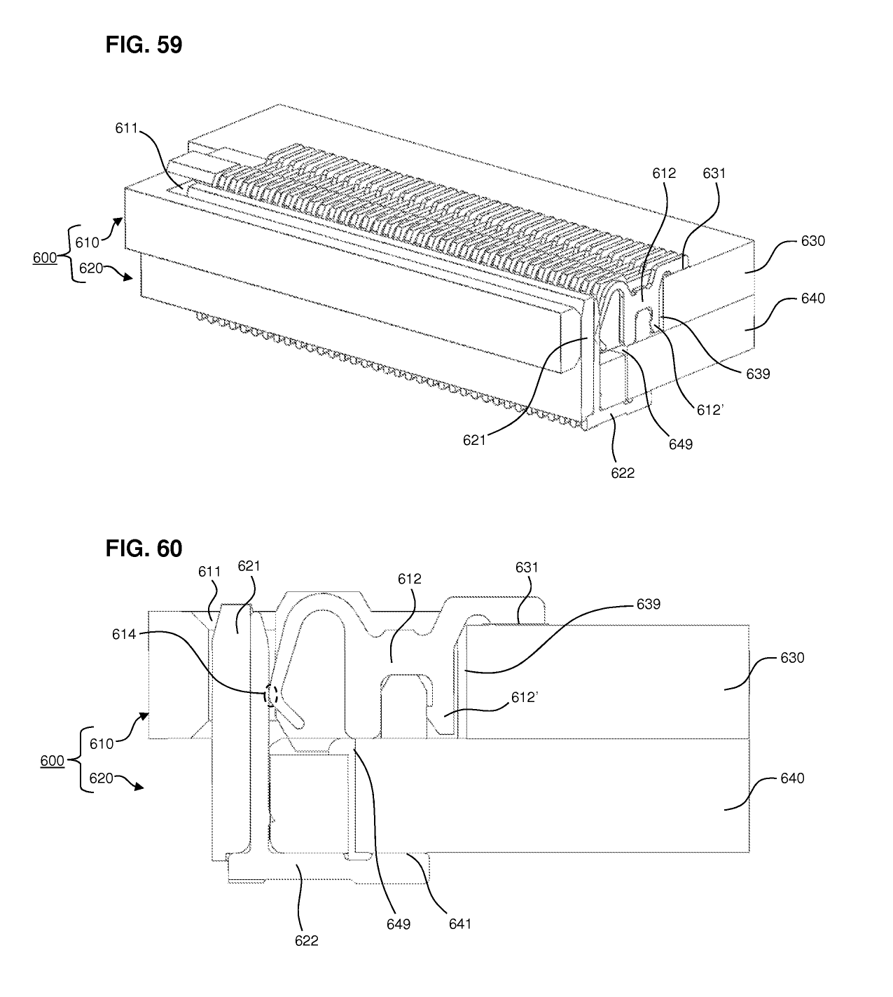

FIGS. 52-60 show a connector 600 in accordance with a seventh preferred embodiment of the present invention. FIGS. 52-55 are perspective views and a cross-sectional perspective view of the connector 600, which includes a socket 610 and a terminal 620 that are respectively connected to respective a first substrate 630 and a second substrate 640. FIG. 56 is a cross-sectional end view of the socket 610, the terminal 620, the first substrate 630, and the second substrate 640 shown in FIGS. 52-55. FIG. 57-60 are perspective views and cross-sectional views of the socket 610, the terminal 620, the first substrate 630, and the second substrate 640 shown in FIGS. 52-55, when the terminal 620 is mated with the socket 610.

As shown in FIGS. 52-60, the socket 610 includes socket contacts 612 that are respectively connected to connection pads 631 of the first substrate 630, and the terminal 620 includes terminal contacts 622 that are respectively attached to connection pads of 641 of the second substrate 640. Preferably, the socket contacts 612 include retaining arms 612′ that are press-fit into corresponding holes in the socket 610 to help secure the socket contacts 612 to the socket 610. As shown in FIGS. 52-60, the socket 610 includes a pass-through hole 611 arranged to receive a beam 621 of the terminal 620 when the terminal 620 is inserted into the socket 610. As shown in FIGS. 52-60, the socket 610 is arranged to fit along an edge 639 of the first substrate 630, and the terminal 620 is arranged to fit along an edge 649 of the second substrate 640.

The socket 610 and the terminal 620 of the connector 600 shown in FIGS. 52-60 are similar to the socket 310 and the terminal 320 of the connector 300 shown in FIGS. 21-27. However, as shown in FIGS. 52-60, the socket 610 only includes one row of socket contacts 612, and the terminal only includes one row of terminal contacts 622. Furthermore, the connection pads 631 and 641 of the first and second substrates 630 and 640 are arranged near or adjacent to the respective edges 639 and 649 of the first and second substrates 630 and 640. Accordingly, the only footprint required by the connector 600 on the first substrate 630 is at the connection between the socket contacts 612 and the connection pads 631 of the first substrate 630, and the only footprint required by the connector 600 on the second substrate 640 is at the connection between the terminal contacts 622 and the connection pads 641 of the second substrate.

As shown in FIGS. 52-56, the socket 610 preferably includes posts 616 that engage with corresponding post holes 626 of the terminal 620 when the terminal 620 is inserted into the socket 620 to help ensure proper alignment between the socket contacts 612 and the terminal contacts 622 and proper orientation of the socket 610 and the terminal 620. Further, since the posts 616 of the socket 610 engage with the post holes 626 of the terminal 620 when the terminal 620 is mated with the socket 610, rotation and twisting of the socket 610 and the terminal 620 with respect to each other is inhibited while the terminal 620 is fully mated with the socket 610.

As shown in FIGS. 52-60, the above-described arrangement of the socket 610 and the terminal 620 provides a stable physical and electrical connection between the socket 610 and the terminal 620.

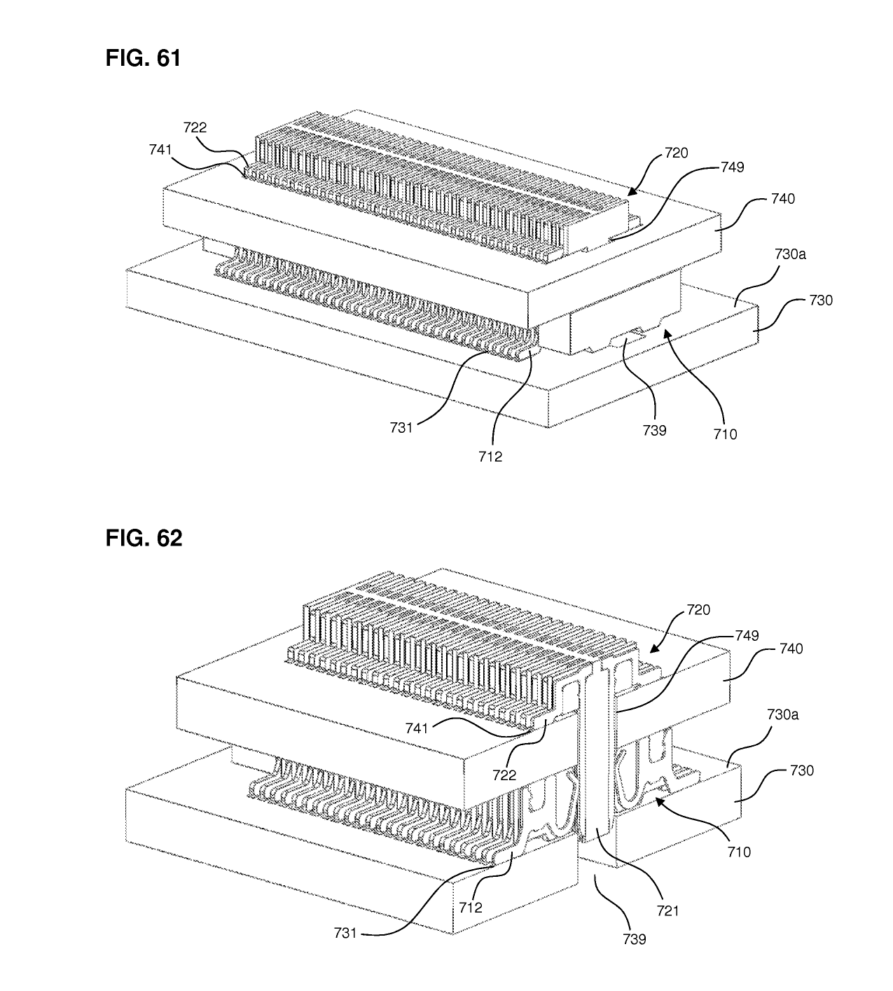

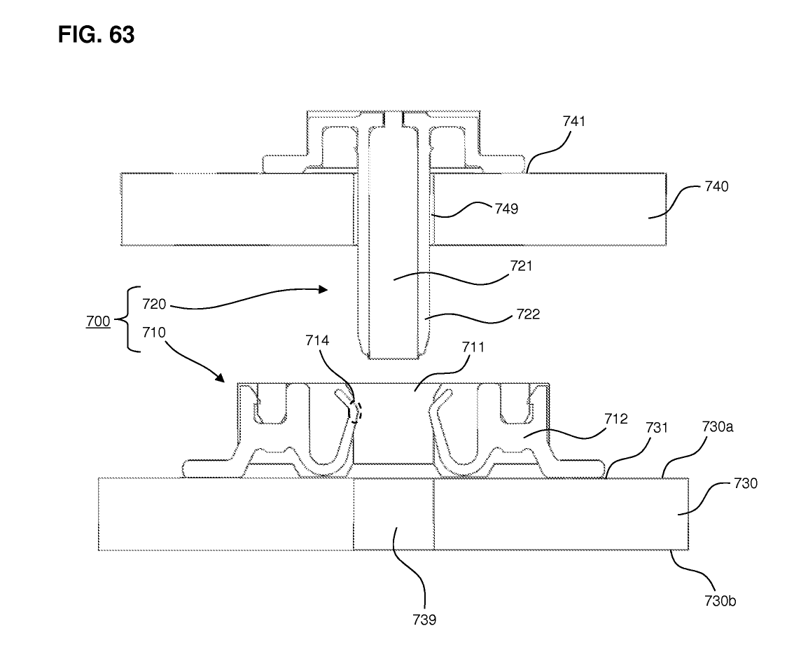

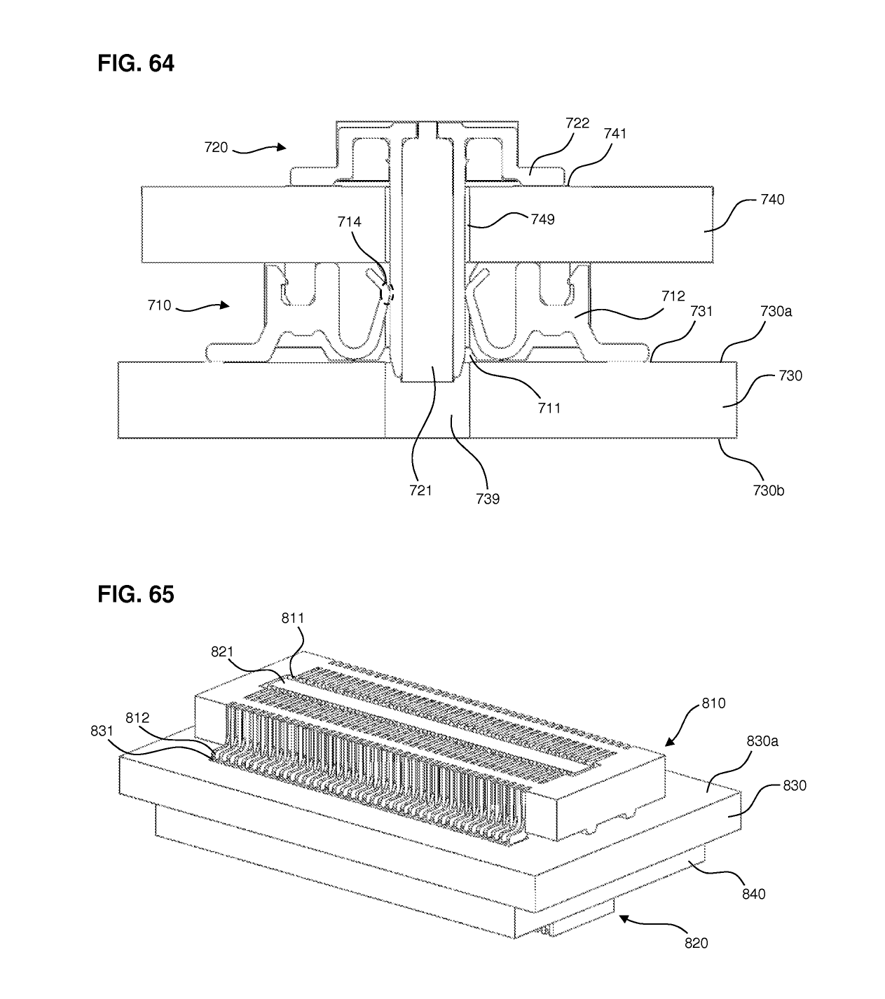

FIGS. 61-64 show a connector 700 in accordance with an eighth preferred embodiment of the present invention. FIGS. 61 and 62 are a perspective view and a cross-sectional perspective view of the connector 700, which includes a socket 710 and a terminal 720 that are respectively connected to a first substrate 730 and a second substrate 740. FIG. 63 is a cross-sectional end view of the socket 710, the terminal 720, the first substrate 730, and the second substrate 740 shown in FIGS. 61 and 62. FIG. 64 is a cross-sectional end view of the socket 710, the terminal 720, the first substrate 730, and the second substrate 740 shown in FIGS. 61 and 62, when the terminal 720 is mated with the socket 710.

As shown in FIGS. 61-64, the socket 710 includes socket contacts 712 that are respectively connected to connection pads 731 on a first surface 730a of the first substrate 730, and the terminal 720 includes terminal contacts 722 that are respectively attached to connection pads 741 of the second substrate 740. The second substrate 740 includes a cut-out 749 arranged to receive a beam 721 of the terminal 720.

As shown in FIGS. 62-64, the socket 710 includes a pass-through hole 711 arranged to receive the beam 721 of the terminal 720 when the terminal 720 is inserted into the socket 710. The first substrate 730 includes a cut-out 739 arranged to receive the beam 721 of the terminal 720 when the terminal 720 is inserted into the socket 710. As shown in FIGS. 62 and 64, the beam 721 preferably passes through a plane defined by the first surface 730a of the first substrate 730 but does not pass through a plane defined by a second surface 730b of the first substrate 730. According to preferred embodiments of the present invention, the beam 721 may pass fully through the first substrate 730, or the cut-out 739 of the first substrate 730 may be formed as a recess such that the cut-out 739 does not extend through to the second substrate 730.

Because the beam 721 of the terminal 720 passes through the cut-out 749 of the second substrate, through the pass-through hole 711 of the socket 710, and into the cut-out 739 of the first substrate 730, the terminal contacts 722 are held at a stable position with respect to contact points 714 of the socket contacts 712 when the terminal 720 and the socket 710 are mated. In addition, the above-described arrangement of the socket 710 and the terminal 720 provides a long wipe distance between the socket contacts 712 and the terminal contacts 722. Accordingly, a stable physical and electrical connection is provided between the socket 710 and the terminal 720.

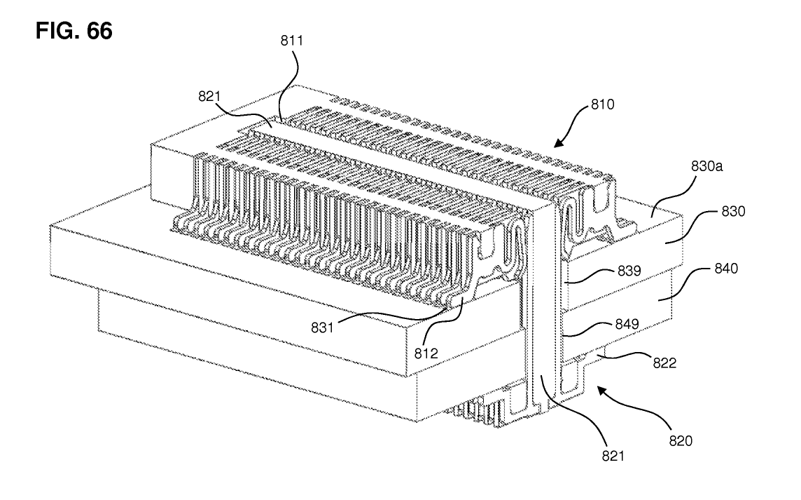

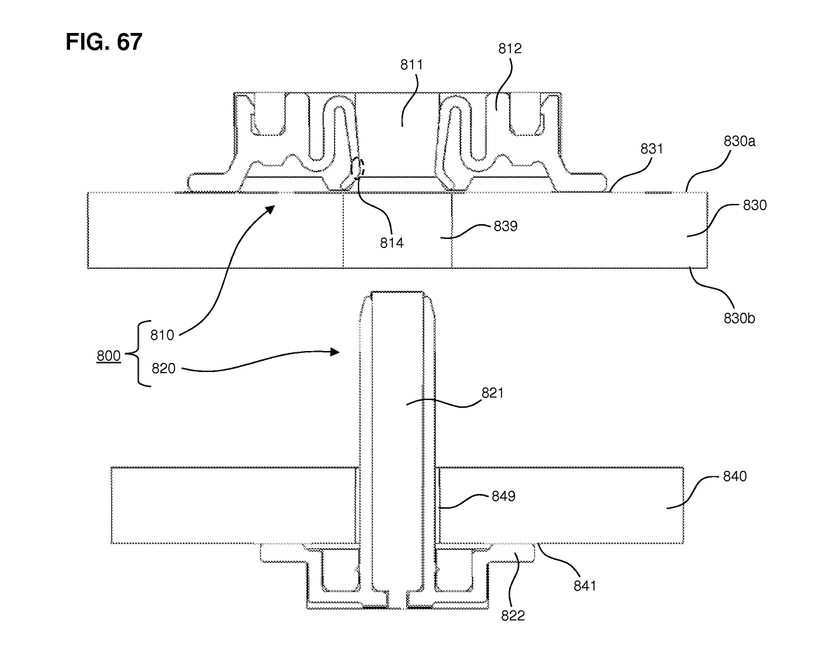

FIGS. 65-66 show a connector 800 in accordance with a ninth preferred embodiment of the present invention. FIGS. 65 and 66 are a perspective view and a cross-sectional perspective view of the connector 800, which includes a socket 810 and a terminal 820 that are respectively connected to a first substrate 830 and a second substrate 840. FIG. 67 is a cross-sectional end view of the socket 810, the terminal 820, the first substrate 830, and the second substrate 840 shown in FIGS. 65 and 66. FIG. 68 is a cross-sectional end view of the socket 810, the terminal 820, the first substrate 830, and the second substrate 840 shown in FIGS. 65 and 66, when the terminal 820 is mated with the socket 810.

As shown in FIGS. 65-68, the socket 810 includes socket contacts 812 that are respectively connected to connection pads 831 on a first surface 830a of the first substrate 830, and the terminal 820 includes terminal contacts 822 that are respectively attached to connection pads 841 of the second substrate 840. The second substrate 840 includes a cut-out 849 arranged to receive a beam 821 of the terminal 820.

As shown in FIGS. 65-68, the socket 810 includes a pass-through hole 811 arranged to receive the beam 821 of the terminal 820 when the terminal 820 is inserted into the socket 810. The first substrate 830 includes a cut-out 839 arranged to receive the beam 821 of the terminal 820 when the terminal 820 is inserted into the socket 810. As shown in FIGS. 66 and 68, the beam 821 preferably passes fully through the planes defined by the first surface 830a and a second surface 830b of the first substrate 830. Preferably, a distal surface of the beam 821 that is farthest away from the second substrate 840 is co-planar or substantially co-planar, within manufacturing tolerances, to a surface of the socket 810 that is farthest away from the first surface 830a. According to preferred embodiments of the present invention, the beam 821 may pass fully through the pass-through hole 811 of the socket 810, or the distal surface of the beam may be arranged between the major planar surfaces of the socket 810 when the terminal 820 is fully mated with the socket 810.

Because the beam 821 of the terminal 820 passes through the cut-out 849 of the second substrate, through the cut-out 839 of the first substrate 830, and into the pass-through hole 811 of the socket 810, the terminal contacts 822 are held at a stable position with respect to contact points 814 of the socket contacts 812 when the terminal 820 and the socket 810 are mated. In addition, the above-described arrangement of the socket 810 and the terminal 820 provides a long wipe distance between the socket contacts 812 and the terminal contacts 822. Accordingly, a stable physical and electrical connection is provided between the socket 810 and the terminal 820.

The sockets 110, 310, 410, 510, 710, and 810 and the terminals 120, 120′, 220, 320, 420, 520, 620, 720, and 820 can be secured to the first substrates 130, 330, 430, 530, 730, and 830 and the second substrates 240, 340, 440, 540, 740, and 840, respectively, only by the connection between the connection pads 131, 141, 241, 331, 341, 431, 441, 531, 541, 631, 641, 731, 741, 831, and 841 and the contacts 112, 122, 122′, 222, 312, 322, 412, 422, 512, 522, 612, 622, 712, 722, 812, and 822. However, retention tabs can be included in the sockets 110, 310, 410, 510, 710, and 810 and/or the terminals 120, 120′, 220, 320, 420, 520, 620, 720, and 820 to provide additional connections that secure the sockets 110, 310, 410, 510, 710, and 810 and/or the terminals 120, 120′, 220, 320, 420, 520, 620, 720, and 820, respectively, to the first substrates 130, 330, 430, 530, 730, and 830 and/or the second substrates 240, 340, 440, 540, 740, and 840. Preferably, the retention tabs are secured to the first substrates 130, 330, 430, 530, 730, and 830 and/or the second substrates 240, 340, 440, 540, 740, and 840 by a fusible material, such as solder. Screw downs, plastic board locks, solder locks, or other similar elements can be used to secure the sockets 110, 310, 410, 510, 710, and 810 and/or the terminals 120, 120′, 220, 320, 420, 520, 620, 720, and 820 to the first substrates 130, 330, 430, 530, 730, and 830 and/or the second substrates 240, 340, 440, 540, 740, and 840. The retention tabs, screw downs, plastic board locks, solder locks, or other similar elements provide a more rugged and secure connection to the first substrates 130, 330, 430, 530, 730, and 830 and/or the second substrates 240, 340, 440, 540, 740, and 840, for example, if the connectors 100, 200, 300, 400, 500, 600, 700, and 800 require a high number of mating and un-mating operations. However, the retention tabs, screw downs, plastic board locks, solder locks, or other similar elements increase the footprint required on the first substrates 130, 330, 430, 530, 730, and 830 and/or the second substrates 240, 340, 440, 540, 740, and 840.

While preferred embodiments of the present invention show the sockets 110, 310, 410, and 510 preferably being fit into respective cut-outs 139, 339, 439, and 539 of the first substrates 130, 330, 430, and 530, the first substrates 130, 330, 430, and 530 may instead be provided with a recess that does not extend through the first substrates 130, 330, 430, and 530 in place of the cut-outs 139, 339, 439, and 539. Similarly, while preferred embodiments of the present invention show the terminals 220, 320, 420, and 520 preferably being fit into respective cut-outs 249, 349, 449, and 549 of the second substrates 240, 340, 440, and 540, the second substrates 240, 340, 440, and 540 may instead be provided with a recess that does not extend through the second substrates 240, 340, 440, and 540 in place of the cut-outs 249, 349, 449, and 549.

For example, the recesses may be included in place of the cut-outs 139, 249, 339, 349, 439, 449, 539, and 549 if the first and/or second substrates 130, 240, 330, 340, 430, 440, 530, and 540 are relatively thick substrates, if it is desired to include routing in the first and/or second substrates 130, 240, 330, 340, 430, 440, 530, and 540 under the connectors 100, 200, 300, 400, and 500, or if electrical traces are included on the sides of the first and/or second substrates 130, 240, 330, 340, 430, 440, 530, and 540 that are opposite to the connectors 100, 200, 300, 400, and 500. That is, using recesses in place of the cut-outs 139, 249, 339, 349, 439, 449, 539, and 549 allows for additional routing to be included in the first and/or second substrates 130, 240, 330, 340, 430, 440, 530, and 540.

Preferably, the wipe distances between the socket contacts 112, 312, 412, 512, 612, 712, and 812 and the terminal contacts 122, 122′, 222, 322, 422, 522, 622, 722, and 822 are related to the overall size of the connectors 100, 200, 300, 400, 500, 600, 700, and 800. Further, the normal forces at the contact points 114, 314, 514, 614, 714, and 814 are also preferably related to the overall size of the connectors 100, 200, 300, 400, 500, 600, 700, and 800. For example, a larger connector having a pitch of about 2 mm to 0.100″ and having a connector height of about 4 mm or greater preferably has a wipe distance of about 0.100″ and a normal force of about 100 grams. As another example, a smaller connector having a pitch of about 0.5 mm or 0.025″ and a connector height of about 3 mm preferably has a wipe distance of about 0.015″ and a normal force of about 25 grams. As yet another example, an even smaller connector preferably has a wipe distance of about 0.001″ and a normal force of about 15 grams.

The socket contacts 112, 312, 512, 612, 712, and 812 and the terminal contact 424 preferably have spring shapes with one or more bent portions that form the contact points 114, 314, 424, 515, 615, 714, and 814. The terminal contacts 122, 122′, 222, 322, 522, 622, 722, and 822 and the socket contact 412 preferably have a straight portion that is arranged to engage with a corresponding one of the contact points 114, 314, 424, 514, 614, 714, and 814. However, according to preferred embodiments of the present invention, the terminal contacts 122, 122′, 222, 322, 522, 622, 722, and 822 and the socket contact 412 may also have spring shapes, either in place of or in addition to the spring shapes of the socket contacts 112, 312, 512, 612, 712, and 812 and the terminal contact 424. Preferably, contacts having spring shapes are used for both the socket contacts and the terminal contacts in connectors that have relatively small pitch heights and/or relatively small profile heights, for example, to increase the mating force between the socket and the terminal.

According to preferred embodiments of the present invention, each row of the socket connectors 110, 310, 410, 510, 710, and 810 may be formed in a separate sub-connector, for example, to allow the sub-connectors to include different types of contacts, to have different tolerance variations, and the like. The sub-connectors may be arranged to form the full socket connectors 110, 310, 410, 510, 710, and 810 either before or after insertion into the corresponding first substrates 130, 330, 430, 530, 730, and 830.

According to preferred embodiments of the present invention, the sockets 110, 310, 410, 510, 610, 710, and 810 and the terminals 120, 120′, 220, 320, 420, 520, 620, 720, and 820 may include, as an insulating material, any thermoplastic material, thermoset material, ceramic material, glass, or similar dielectric material. Further, the socket contacts 112, 312, 412, 512, 612, 712, and 812 and the terminal contacts 122, 122′, 222, 322, 422, 522, 622, 722, and 822 may include any copper alloy material.

According to preferred embodiments of the present invention, the terminals 120, 120′, 220, 320, 420, 520, 620, 720, and 820 and the plug 120 and 220 of U.S. patent application Ser. No. 13/688,392 may be mated with any one of the sockets 110, 310, 410, 510, 710, and 810 and of the receptacles 110 and 210 of U.S. patent application Ser. No. 13/688,392. For example, the terminal 720 shown in FIGS. 61-64 may be connected with the socket 110 shown in FIGS. 1-9. Furthermore, the terminals 120, 120′, 220, 320, 420, 520, 620, 720, and 820 may be inserted into any one of the sockets 110, 310, 410, 510, 710, and 810 in any of the directions shown and described above with respect to FIGS. 1-68, or in directions that are opposite to those shown and described above with respect to FIGS. 1-68.

According to preferred embodiments of the present invention, an edge card, such as the edge card 350, may be mated with any one of the sockets 110, 310, 410, 510, 710, and 810. Furthermore, the edge card may include connection pads on only one or on both of the major planar surfaces of the edge card, according to the corresponding one of the sockets 110, 310, 410, 510, 710, and 810. The edge card may be mated with the sockets 110, 310, 410, 510, 710, and 810 in either the direction shown in FIGS. 28-33 with respect to edge card 350, or in a direction opposite to the direction shown in FIGS. 28-33.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A connector system comprising:
a first connector including a pass-through hole or a recess and a first plurality of contacts arranged in at least one row around the pass-through hole or the recess, the first connector being configured to be located in a cut-out of a first substrate such that the first plurality of contacts are connected to the first substrate; and
a second connector including a beam and a second plurality of contacts arranged in at least one row around the beam, the second connector configured to be located in a cut-out of the second substrate such that the second plurality of contacts are connected to the second substrate; wherein
the pass-through hole or the recess extends in a mating direction of the first connector and the second connector;
the beam of the second connector is configured to extend into the pass-through hole or the recess of the first connector when the first connector and the second connector are mated such that each of the first plurality of contacts engages with a respective one of the second plurality of contacts;
a contact point between the first plurality of contacts and the second plurality of contacts when the first connector is mated with the second connector is located between facing major planar surfaces of the first substrate and the second substrate, or between a first major planar surface and a second major planar surface of the first substrate; and
a bottom surface of the beam of the second connector is arranged between the first and second major planar surfaces of the first substrate when the first connector is mated with the second connector, or the bottom surface of the beam of the second connector is co-planar or substantially co-planar to a first major planar surface and a second major planar surface of the first connector when the first connector is mated with the second connector.
